(19) United States
(12) Patent Application Publication
(10) Pub. No.: US 2006/0058921 A1
(43) Pub. Date: Mar. 16, 2006

(54) Mobile robot

(76) Inventor: Tamao Okamoto, Nishinomiya-shi (JP)

Correspondence Address: WENDEROTH, LIND & PONACK L.L.P., 2033 K. STREET, NW, SUITE 800, WASHINGTON, DC, 20006, US

(21) Appl. No.: 11/222,963

(22) Filed: Sep. 12, 2005

(30) Foreign Application Priority Data
Sep. 13, 2004 (JP) 2004-264769

(51) Int. Cl. G06F 19/00

(52) U.S. Cl. 700/255; 701/25; 700/245

(57) ABSTRACT

A mobile robot having a movable main unit section, a self location measurement unit for measuring a self location of the main unit section, a map database for storing map information on a travel range of the main unit section to a travel destination, a virtual sensor information calculation unit for extracting information on obstacles to movement of the main unit section in an arbitrary detection region on the map information based on self location information measured by the self location measurement unit and the map information stored in the map database, and for calculating virtual sensor calculation information, and a route calculation unit for calculating a travel route for the main unit section to travel based on the virtual sensor calculation information calculated by the virtual sensor information calculation unit.

### BACKGROUND OF THE INVENTION

The present invention relates to a mobile robot.

One of methods for moving a mobile robot to a destination under the environment that obstacles are present is composed of the steps of detecting locations of obstacles by a plurality of obstacle detection sensors mounted on the mobile robot, calculating a travel route for the mobile robot to avoid the obstacles based on information on a present location of the mobile robot and information on the locations of the obstacles detected by the obstacle detection sensors, and moving the mobile robot along the route (see, e.g., Patent Document 1 (Japanese Unexamined Patent Publication No. H07-110711)).

Herein, the outline of a mobile robot in a conventional example 1 disclosed in the Patent Document 1 will be described with reference to FIG. 7A, FIG. 7B, FIG. 7C and FIG. 8. FIG. 7A, FIG. 7B and FIG. 7C show a configuration of the mobile robot disclosed in the Patent Document 1. FIG. 8 shows a method for determining a travel route of the mobile robot shown in FIG. 7A, FIG. 7B and FIG. 7C.

As shown in FIG. 7A, FIG. 7B and FIG. 7C, the mobile robot 171 is composed of a movable main unit section 171a having wheels 178 and auxiliary wheels 179 necessary for moving the robot as well as drive units 175 such as motors; an obstacle detection sensor 177 mounted at the periphery of the main unit section 171a, for detecting obstacles present in a surrounding arbitrary detection region with use of ultrasonic waves or infrared rays; a self location measurement unit 172 for measuring a present location of the robot (hereinbelow referred to as a self location) through calculation of encoder values, which are measured by encoders 161 mounted on, for example, wheel shafts, by means of an odometry calculation unit 162; and a route calculating unit 174 for calculating a route to avoid obstacles and reach a destination based on the information on the obstacles detected by the obstacle detection sensor 177 and the self location information on the mobile robot 171 measured by the self location measurement unit 172.

Such a travel route of the mobile robot 171 is determined as shown in, for example, FIG. 8A. More specifically, while the mobile robot 171 is moving toward a destination 183 as shown in, for example, FIG. 8A, if there is no obstacle finding its way into a detection region 182 of the obstacle detection sensor 177 in the direction of travel, then the route calculating unit 174 in the mobile robot 171 calculates a route 185 to the destination 183 shown by a solid arrow in FIG. 8A based on the self location measured by the self location measurement unit 172 and location information on the destination 183, and the mobile robot 171 travels along the route 185.

However, while the mobile robot 171 is moving, for example, if an obstacle 184 finds its way into the detection region 182 of the obstacle detection sensor 177 in the direction of travel as shown in FIG. 8B, then the obstacle detection sensor 177 measures a direction and a distance from the mobile robot 171 to the obstacle 184, and the route calculating unit 174 calculates a route based on information on the obstacle 184 measured by the obstacle detection sensor 177 in addition to the self location information measured by the self location measurement unit 172 and the location information on the travel destination 183. The route to be calculated is, for example, a route 187 synthesized from an obstacle avoidance component 186 which size is inversely proportional to a distance between the mobile robot 171 and the obstacle 184 and which is in a direction opposite to the obstacle 184 and from the route 185 in the case without any obstacle. Thus, as the mobile robot 171 travels along the route calculated in real time based on the obstacle information around the mobile robot 171, the mobile robot 171 avoids the obstacle 184 and reaches the destination 183.

There is another method in which unlike the mobile robot 171 shown in FIG. 7A, FIG. 7B, FIG. 7C, FIG. 8A, and FIG. 8B, a mobile robot has, for example, information on a travel destination of the mobile robot and information on obstacles in a travel range of the mobile robot as map information, and the map information is used as it is to calculate a travel route of the mobile robot (see, e.g., Patent Document 2 (Japanese Unexamined Patent Publication No. H06-138940)).

Herein, the outline of the mobile robot in a conventional example 2 disclosed in the Patent Document 2 will be described with reference to FIG. 10A, FIG. 10B, FIG. 10C, and FIG. 11. FIG. 10A, FIG. 10B, and FIG. 10C show a configuration of the mobile robot disclosed in the Patent Document 2. FIG. 11 shows a method for determining a travel route of the mobile robot shown in FIG. 10A, FIG. 10B, and FIG. 10C.

As shown in FIG. 10A, FIG. 10B, and FIG. 10C, the mobile robot 201 is composed of a movable main unit section 201a having wheels 207 and auxiliary wheels 208 necessary for moving the robot as well as drive units 205 such as motors; a self location measurement unit 202 for measuring a present location of the robot 201 (hereinbelow referred to as a self location) through calculation of encoder values, which are measured by encoders 209 mounted on, for example, wheel shafts, by means of an odometry calculation unit 230; a map database 203 for storing information on the location of a destination, information on locations of obstacles where the obstacles are, and map information about a travel range of the mobile robot 201; and a route calculating unit 204 for calculating a travel route to avoid the obstacles based on the self location information on the mobile robot 201 measured by the self location measurement unit 202 and the map information in the map database 203.

The travel route of the mobile robot 201 is determined as shown in FIG. 11. A location of the robot 201 and a destination 303 are set in map information 301 based on the self location information measured by the self location measurement unit. Herein, for example, in conformity with a required movement accuracy, the map information 301 in the drawing is divided into mesh-like blocks, and a route is determined by sequentially tracking blocks starting from a block where the mobile robot 201 exists to a block where the travel destination 303 exists without passing those blocks where obstacles 304 exist as shown in an enlarged view 307. In this case, since each block has a plurality of movable directions as shown by reference numeral 308, there are a plurality of routes which track these movable directions as shown by reference numeral 309 as an example. Consequently, a plurality of candidate routes reaching the destination 303 are calculated as shown by reference numeral 305, and a route 306 is uniquely selected under the condition of, for example, a shortest route.

However, in the case of the mobile robot 171 in the conventional example 1 shown in FIG. 7A, FIG. 7B, FIG. 7C, and FIG. 8 in which the route is calculated based on the obstacle information detected by the obstacle detection sensor 177, the obstacle detection sensor 177 have limitations in the range of the detection region 182, and therefore it is not possible to predict beyond the calculated route. This causes such inefficient movements as the mobile robot going into a passage with a dead end or into a hollow of an obstacle. Further, in the worst case, there is the possibility that the mobile robot might be trapped in the dead end spot and put into a so-called deadlock state.

The detail thereof will be described with reference to FIG. 9. FIG. 9 shows an ineffective movement of the mobile robot 171 in the conventional example 1 and the deadlock state thereof.

As shown in FIG. 9, when, for example, an obstacle 194 having an aperture portion 197 large enough for the mobile robot 171 to pass and having a hollow with a dead end 198 is present in the direction of a destination 183, an original route 195 toward the destination 183 brings the mobile robot 171 not to the destination but to the dead end, and therefore it is desirable that the mobile robot 171 goes to the destination 183 while following an ideal route 196 which avoids the entire obstacle 194 in advance.

However, since the detection region 182 of the obstacle detection sensor 177 in the mobile robot 171 is limited to around the mobile robot 171 as described before, the mobile robot 171 detects the presence of obstacles on both sides of the mobile robot 171 in the vicinity of the aperture portion 197 of the hollow of the obstacle 194, and if the width of the aperture portion 197 is large enough for the mobile robot 171 to pass, then the mobile robot 171 follows the route 195 and goes deep into the inmost recess from the aperture portion 197. At this point, the dead end 198 of the hollow is not yet detected. Then, the mobile robot 171 follows the route 195 and it is possible, after the mobile robot 171 reaches the dead end 198, that it can detect impassability, escape the hollow, and select a different route. Moreover, in the worst case, a movement component to prompt movement in the direction of the route 195 and a component to prompt avoidance of the dead end may be combined to trap the mobile robot 171 in the dead end, thereby creating the deadlock state.

In the meanwhile, in the case of the mobile robot 201 in the conventional example 2 shown in FIG. 10A, FIG. 10B, FIG. 10C, and FIG. 11 in which the route is calculated based on the map information stored in the map database 203, the route calculation using the map information is performed targeting the entire travel range, and in the case where, for example, a number of obstacles 304 are present or the map information is large in size, a calculation amount in the route calculation becomes huge, making it difficult for processors mounted on the small-size mobile robot to execute real time processing.

For example, it is known that calculation of the shortest route from a certain point to a travel destination 303 requires a calculation amount proportional to the square of reference points (reference area/movement accuracy) from the graph theory as shown in the above example. For example, movement of only 1 m square per 1 cm accuracy requires 100×100, i.e., 10000 reference points, and a calculation amount necessary for the route calculation in this case becomes as huge as K×10⁸ (K is a proportionality constant). For comparison, a calculation amount in the case of the robot in the conventional example 1 is in proportion to the number of sensors.

An object of the present invention is to provide a mobile robot moving under the environment that obstacles are present, the mobile robot capable of achieving real time and efficient travels to destinations to solve those issues.

### SUMMARY OF THE INVENTION

In order to accomplish the object, the present invention is described as shown below.

According to a first aspect of the present invention, there is provided a mobile robot comprising:
a movable robot main unit section;
a self location measurement unit for measuring a self location of the main unit section;
a map database for storing map information on a travel range of the main unit section;
an obstacle information extraction section for extracting obstacle information on obstacles to movement of the main unit section in a detection region of a virtual sensor set on the map information and capable of detecting the obstacle information, based on self location information measured by the self location measurement unit and the map information stored in the map database; and
a route calculation unit for calculating a travel route for the main unit section to travel based on the obstacle information extracted by the obstacle information extraction section.

According to a second aspect of the present invention, there is provided the mobile robot as defined in the first aspect, further comprising an obstacle detection sensor for detecting an obstacle in a detection region around the main unit section, wherein the route calculation unit calculates the travel route for the main unit section to travel based on detection information from the obstacle detection sensor in addition to the obstacle information extracted by the obstacle information extraction section.

According to a third aspect of the present invention, there is provided the mobile robot as defined in the second aspect, further comprising a conversion unit for converting the obstacle information extracted by the obstacle information extraction section into a signal identical to a signal outputted as the detection information into the route calculation unit by the obstacle detection sensor and outputting the converted signal to the route calculation unit.

According to a fourth aspect of the present invention, there is provided the mobile robot as defined in the first aspect, further comprising a virtual sensor setting change unit for changing extraction conditions for the obstacle information extraction section to extract the obstacle information.

According to a fifth aspect of the present invention, there is provided the mobile robot as defined in the second aspect, further comprising a virtual sensor setting change unit for changing extraction conditions for the obstacle information extraction section to extract the obstacle information.

According to a sixth aspect of the present invention, there is provided the mobile robot as defined in the third aspect, further comprising a virtual sensor setting change unit for changing extraction conditions for the obstacle information extraction section to extract the obstacle information.

According to a seventh aspect of the present invention, there is provided the mobile robot as defined in the fifth aspect, wherein the virtual sensor setting change unit changes extraction conditions for the obstacle information extraction section to extract the obstacle information based on at least any one of the map information stored in the map database, the self location information measured by the self location measurement unit, the obstacle information extracted by the obstacle information extraction section, the detection information by the obstacle detection sensor, and the travel route calculated by the route calculation unit.

According to an eighth aspect of the present invention, there is provided the mobile robot as defined in the sixth aspect, wherein the virtual sensor setting change unit changes extraction conditions for the obstacle information extraction section to extract the obstacle information based on at least any one of the map information stored in the map database, the self location information measured by the self location measurement unit, the obstacle information extracted by the obstacle information extraction section, the detection information by the obstacle detection sensor, and the travel route calculated by the route calculation unit.

According to the thus-structured configuration, the sensor information is virtually calculated based on the map information, which eliminates such physical restrictions peculiar to actual obstacle detection sensors that “the distance and range to detectable obstacles are limited”, “the surface physicality of obstacles disturbs detection”, and “interference between sensors disturbs detection”. This makes it possible to set free detection regions according to obstacle environments so as to allow accurate obstacle detection. Therefore, efficient travels to destinations can be implemented compared to the case of using actual obstacle detection sensors only. Moreover, the total calculation amount necessary for the route calculation in the present invention is the sum of a calculation amount proportional to (sensor detection region/movement accuracy) since the calculation in the obstacle information extraction section becomes the calculation to determine whether or not obstacles are present in the detection region and a calculation amount of the route calculation in the conventional example 1, which allows drastic reduction in calculation amount from the case in which the route is directly calculated from the map, thereby enabling such processors as being mounted on small-size mobile robots to perform real time processing.

According to the present invention, extracting the obstacle information in the detection region of the virtual sensor from the map information makes it possible to detect the obstacles which cannot be detected by actual obstacle sensors due to physical restrictions. Further, since a calculation amount during route calculation is considerably reduced from the case in which the route is directly calculated from the map information, the processors mounted on small-size mobile robots can perform real time processing.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1A is a view showing a configuration of a mobile robot in one embodiment of the present invention;

FIG. 1B is a view showing the actual mobile robot and a detection region of its sensor;

FIG. 1C is a view showing the mobile robot on a map and a detection region of its virtual sensor on a map;

FIG. 1D is a view showing a bypass route calculated by the mobile robot shown in FIG. 1A;

FIG. 1E is a view showing a configuration of a mobile robot different from the mobile robot shown in FIG. 1A;

FIG. 1F, FIG. 1G, and FIG. 1H are respectively a perspective view, a perspective plane view, and a block diagram showing the outline of the mobile robot in the embodiment of the present invention;

FIG. 1I is a block diagram showing the outline of a mobile robot without a virtual sensor setting change unit in a modified example of the embodiment in the present invention;

FIG. 2 is a view showing a detection region of an obstacle detection sensor and its detected values;

FIG. 3A is a view showing a detection region of a virtual sensor (described later in detail) in the mobile robot in one embodiment;

FIG. 3B is a view showing a detection region of a virtual sensor (described later in detail) in the mobile robot in another embodiment;

FIG. 3C is a view showing virtual sensor calculation information in the absence of obstacles;

FIG. 3D is a view showing virtual sensor calculation information in the presence of obstacles on the route;

FIG. 3E is a view showing virtual sensor calculation information in the presence of general obstacles;

FIG. 3F is a view showing virtual sensor calculation information in the presence of an impassable obstacle;

FIG. 4A is a view showing map information stored in a map database;

FIG. 4B is a view showing a route calculation method in the absence of obstacles;

FIG. 4C is a view showing a route calculation method in the presence of obstacles;

FIG. 5 is a view showing effects of a signal conversion unit;

FIG. 6A is a view showing a basic processing flow of the mobile robot;

FIG. 6B is a processing flow of the mobile robot in the case of using an obstacle sensor and a virtual sensor setting change unit;

FIG. 7A, FIG. 7B, and FIG. 7C are respectively a perspective view, a perspective plane view, and a block diagram showing the outline of a mobile robot in the conventional example 1;

FIG. 8A and FIG. 8B are views showing a method for determining a travel route of the mobile robot shown in FIG. 7A, FIG. 7B, and FIG. 7C;

FIG. 9 is a view showing the mobile robot in the conventional example 1 put in insufficient movement and in a dead lock state;

FIG. 10A, FIG. 10B, and FIG. 10C are respectively a perspective view, a perspective plane view, and a block diagram showing the outline of a mobile robot in the conventional example 2;

FIG. 11 is a view showing a method for determining a travel route of the mobile robot shown in FIG. 10A, FIG. 10B, and FIG. 10C;

FIG. 12A is an explanatory view for explaining an example in which calculation conditions are changed by a virtual sensor setting change unit based on map information;

FIG. 12B is an explanatory view for explaining a normal setting state of a second detection region;

FIG. 12C is an explanatory view for explaining a setting state of the second detection region for a region having a number of obstacles;

FIG. 13A is an explanatory view for explaining a setting state of the second detection region for slow speed;

FIG. 13B is an explanatory view for explaining a setting state of a second detection region 41s-4 for high speed;

FIG. 14A is an explanatory view for explaining a normal setting region in the state that a first detection region of an obstacle detection sensor and a second detection region of a virtual sensor are set;

FIG. 14B is an explanatory view for explaining the state in which an obstacle is detected in the first detection region of the obstacle detection sensor;

FIG. 14C is an explanatory view for explaining the state in which not only in a front region of the robot but also in a region around the robot, i.e., an omnidirectional region, a present safely stopping distance (a distance to travel till speed stop) is additionally set as the region of a virtual sensor, and obstacle detection is performed in a detection region composed of the additionally set region and the first detection region as well as in the second detection region;

FIG. 14D is an explanatory view for explaining the state in which obstacles are no longer detected in the detection region composed of the additionally set region and the first detection region; and

FIG. 14E is an explanatory view for explaining the state in which a normal setting region is restored.

### DETAILED DESCRIPTION OF THE PREFERRED EMBODIMENTS

Before the description of the present invention proceeds, it is to be noted that like parts are designated by like reference numerals throughout the accompanying drawings.

Hereinbelow, embodiments of the present invention will be described with reference to the figures in detail.

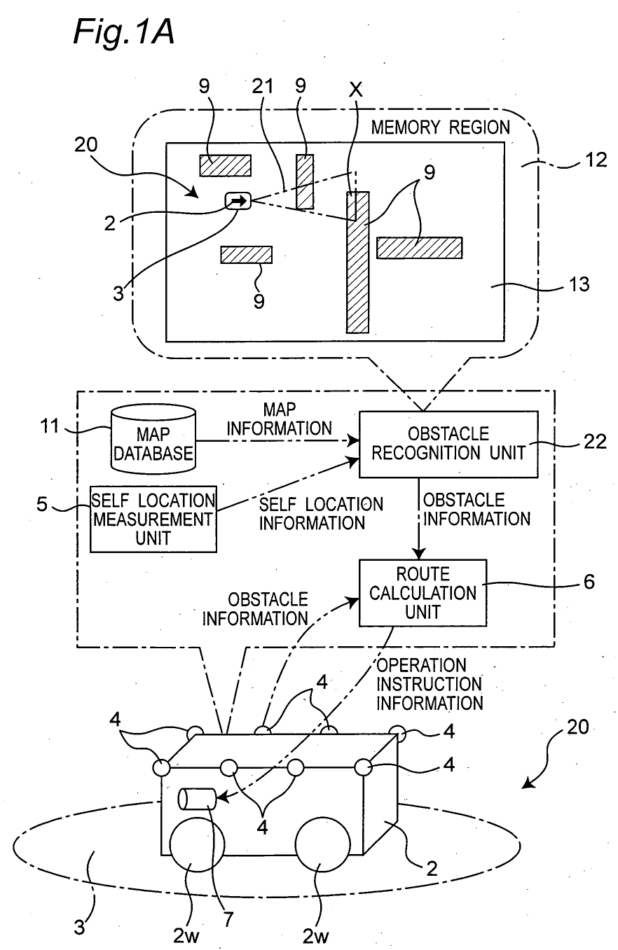

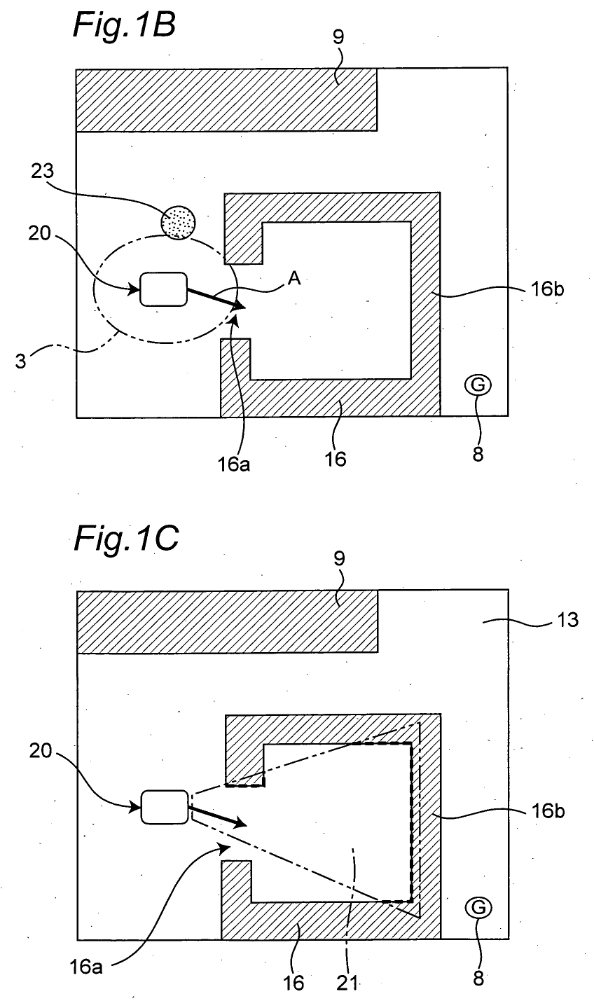

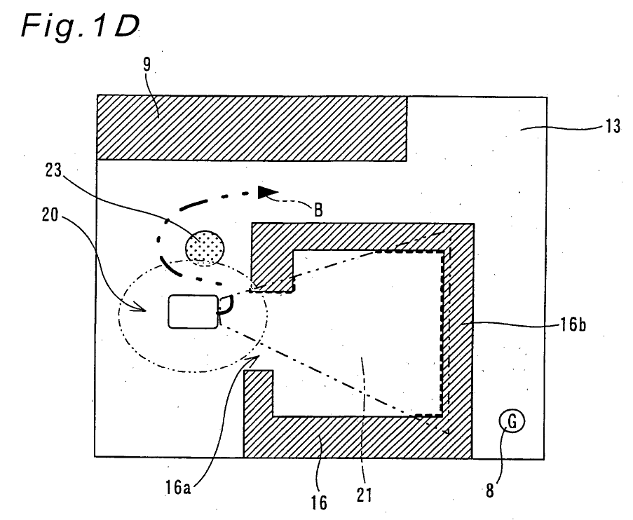

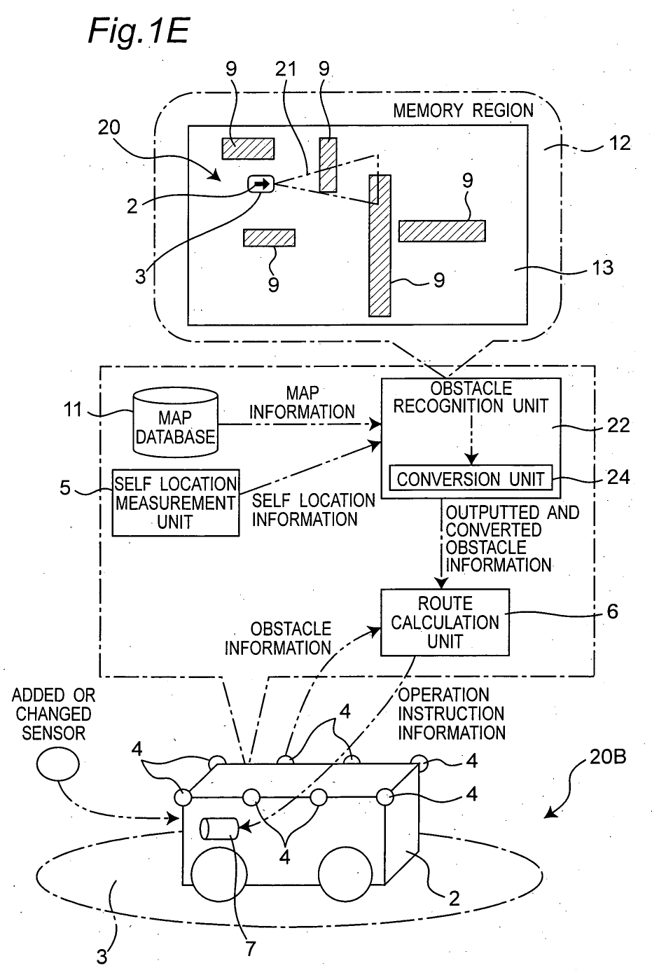

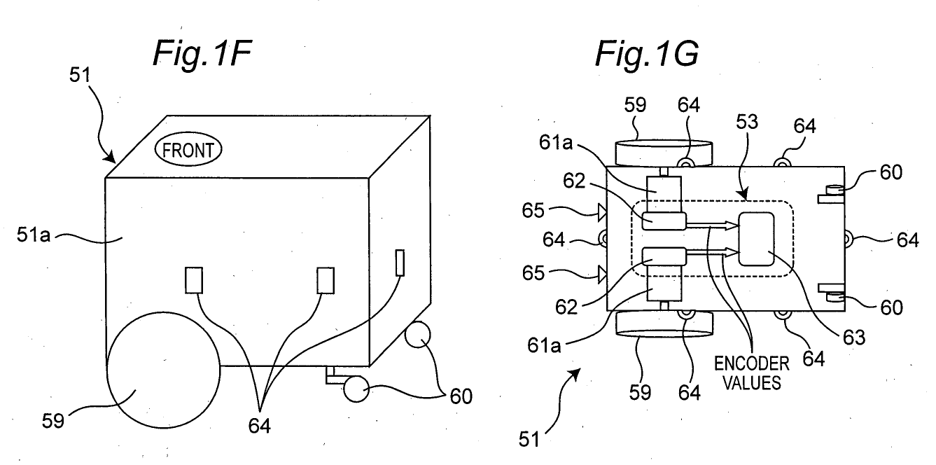

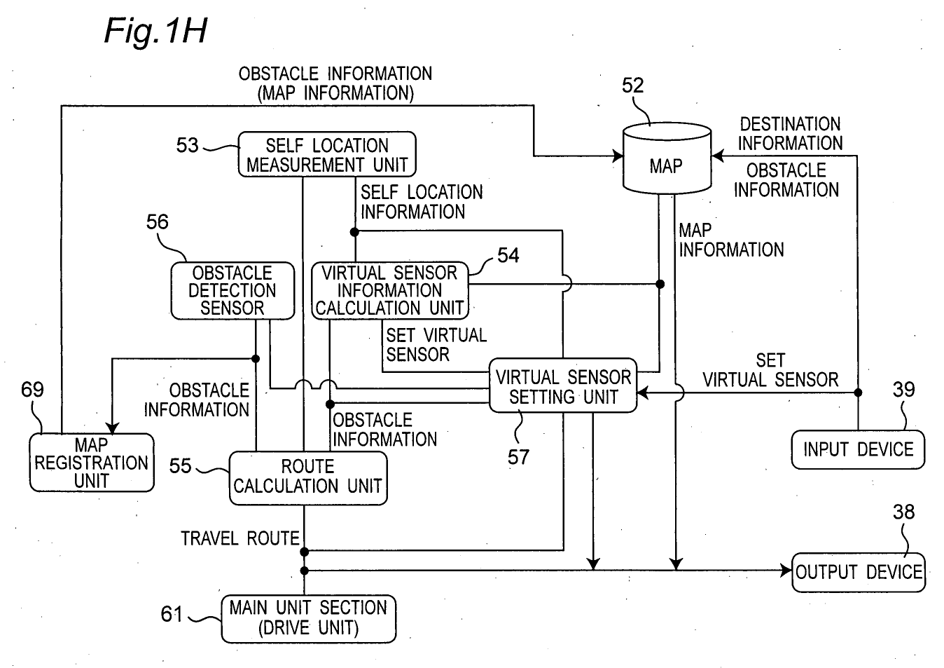

A mobile robot in one embodiment of the present invention will be described with reference to FIG. 1A to FIG. 1E.

FIG. 1A is a view showing a configuration of a mobile robot 20 in the present embodiment, FIG. 1B is a view showing the actual mobile robot 20 and a first detection region 3 of its obstacle detection sensor 4, and FIG. 1C is a view showing the mobile robot 20 on a map 13 and a second detection region 21 of its virtual sensor (described later in detail). FIG. 1D is a view showing a bypass route B calculated by the mobile robot 20, and FIG. 1F is a view showing a configuration of a mobile robot 20B different from the mobile robot 20 shown in FIG. 1A.

As shown in FIG. 1A, the mobile robot 20 is composed of a mobile main unit section 2 in a rectangular parallelepiped shape, a plurality of obstacle detection sensors 4 (four sensors are disposed at upper portions on both sides of the main unit portion 2 in FIG. 1A), a self location measurement unit 5, a map database 11, an obstacle recognition unit 22, a route calculation unit 6, and a drive unit 7.

The main unit portion 2 is movably structured to have four wheels 2w necessary for movement of the mobile robot 20 and a drive unit 7 such as motors.

The plurality of the obstacle detection sensors 4 (four sensors are disposed at the upper portions on both sides of the main unit portion 2 in FIG. 1A) are mounted at the periphery of the main unit portion 2 for detecting obstacles present in the first detection region 3 formed around the main unit portion 2 with use of ultrasonic waves or infrared rays.

The self location measurement unit 5 measures a present location of the robot 20 (hereinbelow referred to as a self location) through calculation of encoder values, which are measured by encoders mounted on wheel shafts of the wheels 2w for example, by means of an odometry calculation unit.

The map database 11 has information about the location of a destination 8, location information on obstacles 9, 16 where the obstacles 9, 16 are present, and map information in the travel range of the main unit portion 2.

The obstacle recognition unit 22 detects known obstacles 9, 16 which are stored in the map database 11 in a memory region 12 and are present in the second detection region 21 of the virtual sensor.

The route calculation unit 6 calculates a bypass route (route to avoid obstacles and reach a travel destination) B for the mobile robot 20, based on the information on the obstacles 9, 16 recognized by the obstacle recognition unit 22, information on an unknown obstacle 23 (see FIG. 1B) present around the main unit portion 2 detected by the obstacle detection sensor 4, and the self location information on the mobile robot 20 measured by the self location measurement unit 5.

The drive unit 7 moves the main unit portion 2 along the calculated bypass route B.

The obstacle recognition unit 22 creates a map (map information) 13 as map graphic data for map in the memory region 12, forms the known obstacles 9, 16 and the main unit portion 2 on the map 13, and sets the virtual sensor having the second detection region 21 capable of detecting the known obstacles 9, 16 present in the second detection region 21 different from the first detection region 3 in the main unit portion 2 so as to detect the obstacles 9, 16 present in the second detection region 21 of the virtual sensor on the map 13.

The virtual sensor is not a real sensor but a sensor allowing the second detection region 21 having a detection function equal to the sensor to be set virtually on the map 13, which enables the obstacle recognition unit 22 to recognize and extract the known obstacles 9, 16 present in the second detection region 21. More specifically, the second detection region 21 of the virtual sensor is preferably a triangular or rectangular region located in front of the mobile robot 20, having a width large enough to house a circle drawn by the mobile robot 20 during its rotation necessary for turning operation (turning operation for avoiding obstacles and the like) (a width two or more times larger than the rotation radius), and having a distance longer than the depth of a hollow of an obstacle having the maximum hollow among the known obstacles on the map 13 viewed from the mobile robot 20. In one mode, this region may be set as a maximum region and the maximum region may be set as the second detection region 21 of the virtual sensor as a default. In another mode, as described in detail later, when any obstacle is not detected, a region smaller than the maximum region, having a length equal to a distance that the mobile robot 20 moves till the mobile robot 20 stops upon reception of a stop instruction while the mobile robot 20 is moving along the travel route (the distance varies depending on the speed of the mobile robot 20), and having a width large enough for a circle drawn by the mobile robot 20 during its rotation for its turning operation (turning operation for avoiding obstacles and the like) to pass (a width two or more times larger than the rotation radius) may be set as a minimum region, and the minimum region may be set as the second detection region 21, and when an obstacle is detected, the setting of the second detection region 21 may be changed to the maximum region. Further, a region (e.g., a region presumed to have a relatively small number of obstacles) where the second detection region 21 of the virtual sensor is set as the minimum region, and a region (e.g., a region presumed to have a relatively large number of obstacles) where the second detection region 21 of the virtual sensor is set as the maximum region may be preset on the map 13.

According to such a virtual sensor, unlike the real sensor, the region and the detection accuracy can be freely set without being subjected to physical conditions of constraint. For example, long distance regions, large regions, regions on the back side of objects, and complicated and labyrinthine regions which are undetectable by real sensors can be detected by the virtual sensor. Further, information which accuracy is too high to be acquired by real sensors is available by the virtual sensor. Moreover, the virtual sensor is free from the problem of interference between sensors, and the virtual sensor does not have to give consideration to issues generated when real sensors are used such as mounting positions, drive sources, interconnections, and piping. Further, the virtual sensor makes it possible to freely change the setting of the sensor such as the detection region and the detection accuracy by switching a program for setting the virtual sensor to another program or by changing parameter values used in the program for setting the virtual sensor. Therefore, with the virtual sensor in use, it is possible to select a low accuracy detection mode during normal time and to change the mode to a high accuracy detection mode upon discovery of an obstacle. Further, with the virtual sensor in use, it is possible to select a mode to detect only in the narrow front region of the robot 20 during normal time and to change the mode to a mode having a wider detection region so as to detect all around the robot 20 when in the places known in advance that a large number of obstacles are present. Thus, according to need, in other words, according to time and place, the detection accuracy and region of the virtual sensor can be set.

Detection of obstacles by the thus-structured virtual sensor is achieved by partial acquisition of information on respective spots in the second detection region 21 on the map 13 (information on presence of obstacles in each spot such as information on the presence/absence of obstacles in the second detection region 21, shapes of the obstacles present in the second detection region 21, distances and directions between the mobile robot 20 to the obstacles in the second detection region 21) from the map database 11. Consequently, while a normal obstacle detection sensor 4 sometimes cannot detect a region on the back side of the obstacle 9 from the mobile robot 20 as shown by reference numeral X in FIG. 1A, the virtual sensor partially acquire the information in the second detection region 21 from the map database 11 so that the obstacle recognition unit 22 can detect the region X on the back side of the obstacle 9 from the mobile robot 20. More particularly, the obstacle recognition unit 22 can detect all the known obstacles 9, 16 if the obstacles 9, 16 are registered in advance in the map database 11 and are present in the second detection region 21, regardless of the positional relationship between the obstacles 9, 16 (in other words, even if the obstacles are overlapped with each other as viewed from the mobile robot 20). It is to be noted that the second detection region 21 of the virtual sensor is set to have, for example, a triangular shape spreading farther ahead to the traveling direction of the main unit portion 2 than the first detection region 3 so that the traveling direction side of the main unit portion 2 than the first detection region 3 can be detected.

Moreover, as described above, the obstacle recognition unit 22 recognizes only the obstacles present in the second detection region 21 and does not recognize those obstacles present outside the second detection region 21. This makes it possible to set only a part of the map 13 in the range of the second detection region 21 as a calculation target for calculation of the bypass route of the mobile robot 20.

With the thus-structured configuration, a method for calculating the bypass route B for preventing the mobile robot 20 from going into the inside of an obstacle 16 having no exit will be described. It is to be noted that the location information on the obstacle 16 is already registered in the map database 11.

In this case, as shown in FIG. 1B, in the mobile robot 20 which is actually traveling toward the destination 8 along a route A, a present location of the mobile robot 20 is measured by the self location measurement unit 5, and the acquired self location information and the map information in the map database 11 are sent to the obstacle recognition unit 22. In the obstacle recognition unit 22, as shown in FIG. 1C, the map 13 is created in the memory region 12 based on the sent map information, while at the same time, a destination 8 as well as obstacles 9, 16 registered in advance in the map database 11 are formed on the map 13. Also, based on the self location information sent from the self location measurement unit 5, the mobile robot 20 is formed on the map 13, while the virtual sensor is given to the mobile robot 20 and the second detection region 21 of the virtual sensor is set. Around the mobile robot 20 which are actually traveling, the known obstacle 9 and obstacle 16 registered in advance in the map database 11 and an unknown obstacle 23 not registered in the map database 11 are present, the obstacle 16 having an aperture portion 16a large enough for the mobile robot 20 to go therein and a dead end portion 16b deeper than the aperture portion 16a, and the destination 8 is present behind the obstacle 16.

Such a travel route of the mobile robot 20 is calculated in such a way that, for example, if there is no obstacle found its way into the first detection region 3 of the obstacle detection sensor 4 in the traveling direction while the mobile robot 20 is moving toward the destination 8, then the mobile robot 20 calculates a route toward the destination 8 in the route calculation unit 6 based on the self location measured by the self location measurement unit 5 and the location information on the destination 8, and the mobile robot 20 travels along the calculated route.

At this point, the obstacle detection sensor 4 in the traveling mobile robot 20 detects a part of the aperture portion-16a-side of the obstacle 16 and a part of the obstacle 23. In the case where the route calculation unit 6 in the mobile robot 20 calculates a bypass route based only on the information on the obstacle 23 detected by the obstacle detection sensor 4, it is not possible to predict ahead the calculated route as the range of the first detection region 3 of the obstacle detection sensor 4 is limited as described in the conventional art, and therefore as shown in FIG. 1B, a bypass route to lead the mobile robot 20 to the inside of the obstacle 16, i.e., a bypass route in the same direction as the route A, is calculated, which may put the mobile robot 20 in the deadlock state inside the obstacle 16 or in perpetual operation.

However, in the mobile robot 20 in the present embodiment, as shown in FIG. 1C, the obstacle recognition unit 22 recognizes the known obstacle 16 present in the second detection region 21 of the virtual sensor set in the mobile robot 20 on the map 13, and since the second detection region 21 is arbitrarily set, setting the second detection region 21 to have a triangular shape expanding farther ahead to the traveling direction side of the main unit portion 2 than the first detection region 3 as shown in FIG. 1C allows the deep inner side of the obstacle 16 to be detected, which therefore makes it possible to detect the presence of the dead end portion 16b in the deep inner side of the obstacle 16.

Thus, using the real obstacle detection sensor 4 makes it possible to detect the unknown obstacle 23 undetectable by the virtual sensor, i.e., not registered in the map database 11, and using the virtual sensor makes it possible to detect the spot of the known obstacle 16 uncovered by the first detection region 3 of the obstacle detection sensor 4. Therefore, using the virtual sensor allows obstacle detection with high accuracy compared to the case using only the obstacle detection sensor 4.

Then, the self location information measured by the self location measurement unit 5, information on the obstacle 23 acquired by the obstacle detection sensor 4 and not registered in advance in the map database 11, and information on the known obstacle 16 detected by the obstacle recognition unit 22 are sent to the route calculation unit 6.

Then, in the route calculation unit 6, as shown in FIG. 1D, based on the self location information of the mobile robot 20 and the location information on the obstacle 23 and the obstacle 16, a bypass route B capable of avoiding the obstacle 23 and the obstacle 16 having the dead end portion 16b in its deep inside is calculated.

At this point, as described above, the obstacle recognition unit 22 recognizes only the obstacles present in the second detection region 21 and does not recognize those obstacles present outside the second detection region 21. This makes it possible to set only a part of the map 13 in the range of the second detection region 21 as a calculation target for calculation of the bypass route of the mobile robot 20, which allows considerable reduction in calculation amount from the case in which the bypass route is calculated with the entire range of the map 13 as a calculation target.

By this, even the processors mounted on small-size mobile robots can promptly calculate bypass routes. Moreover, when a new obstacle is detected during travel, and calculation of a new bypass route becomes necessary again, the new bypass route can be calculated swiftly as the calculation amount is considerably reduced as described above. It is to be noted that in route calculation, both the detection information from the virtual sensor and the detection information from the obstacle detection sensor 4 can be handled as similar sensor information, and the route calculation is performed by solving functions inputted as the sensor information (e.g., as stated in the conventional example 1, functions for calculating a route of the mobile robot by adding a correction amount in a movement component to a movement component toward the destination in conformity with the sensor information, i.e., the direction and the distance to the obstacle). One example of such functions is shown below.
Do(robot route)=F([sensor information])
Example: F([sensor information])=Dt (movement component toward destination)+G (avoidance gain) * L1 (distance to obstacle 1)*
D1 (direction of obstacle 1)+G (avoidance gain) * L2 (distance to obstacle 2)*
D1 (direction of obstacle 2)+ . . .
(repeat by the number of times equal to the number of obstacles)
wherein Do, Dt, D1, D2 . . . are vectors.

Although in the mobile robot 20 shown in FIG. 1A, data processing for recognizing the known obstacle 9 on the map 13 is performed by the obstacle recognition unit 22, while data processing for calculating the bypass route is performed by the route calculation unit 6, these data processing may be performed by one calculation unit. In this case, input and output of detection information on obstacles by the virtual sensor is performed by using the memory in the unit or through an inner communication function.

Moreover, as shown in FIG. 1E, a conversion unit 24 for converting information on the known obstacle 9 recognized by using the virtual sensor into a signal identical to (having the same kind as that of) a signal outputted when the obstacle detection sensor 4 actually detects the obstacle 9 may be included in the obstacle recognition unit 22 of a mobile robot 20B. In this case, since an output signal from the virtual sensor may be made identical to an output signal from the obstacle detection sensor 4 by the conversion unit 24, the effect of adding a sensor or changing its installation position can be tested by changing, for example, the setting of the second detection region 21 in the virtual sensor without actually adding the sensor or changing its installation position. It is also easy to replace the real obstacle detection sensor 4 with a virtual sensor. This makes it possible to test the effect of adding a sensor without actually adding the sensor or changing its installation position in mobile robots in an experimental state or under adjustment.

According to the above embodiment, by creating map graphic data (map information) based on the map database 11, forming the known obstacles and the main unit portion 2 on the graphic data, and setting the virtual sensor capable of detecting the known obstacles 9, 16 present in the second detection region 21 different from the first detection region 3 of the real sensor in the main unit portion 2, for example, the known obstacles 9, 16 whose location information is stored in the map database 11 can be detected by the virtual sensor even in the spots uncovered by the first detection region 3 of the obstacle detection sensor 4 mounted on the main unit portion 2, and using the virtual sensor allows obstacle detection with high accuracy compared to the case in which only the obstacle detection sensor 4 mounted on the main unit portion 2 is used. Moreover, the second detection region 21 in the virtual sensor is used for detecting the known obstacles 9, 16 coming into the second detection region 21 and not for detecting the known obstacles 9, 16 present outside the second detection region 21, and therefore at the time of calculating the bypass route, the route calculation unit 6 can calculate a bypass route based on the information on the known obstacles 9, 16 coming into the second detection region 21 of the virtual sensor and the information on an unknown obstacle among the obstacles detected by the obstacle detection sensor 4 in the main unit portion 2, which allows considerable reduction in calculation amount from the case in which, for example, all the graphic data is set as a calculation target during route calculation.

Therefore, providing the virtual sensor for calculation of the bypass route leads to considerable reduction in calculation amount during route calculation, which enables even the processors mounted on small-size mobile robots to perform real time calculation of bypass routes. Moreover, when a new obstacle is detected during travel and calculation of a new bypass route becomes necessary again, the new bypass route can be calculated in real time in the same manner.

Description is now given of a mobile robot as a more specific example of the embodiment in the present invention with reference to FIG. 1F to FIG. 6.

As shown in FIG. 1F, FIG. 1G, and FIG. 1H, a mobile robot 51 as a more specific example of the embodiment in the present invention is composed of: a mobile main unit section 51a in a rectangular parallelepiped shape; a self location measurement unit 53 for measuring a location of the main unit section 51a; a map database 52 for storing map information on a travel range of the main unit section 51a to a travel destination; a virtual sensor setting change unit 57 for changing setting of calculation conditions for a virtual sensor information calculation unit 54 to calculate virtual sensor calculation information; the virtual sensor information calculation unit (i.e., an obstacle information extraction unit for extracting obstacle information on obstacles to movement of the main unit section 51a in an arbitrary detection region on the map information based on the self location information 73 measured by the self location measurement unit 53 and the map information stored in the map database 52) 54 for extracting obstacle information on obstacles to movement of the main unit section 51a in an arbitrary detection region on the map information based on self location information 73 measured by the self location measurement unit 53 and the map information stored in the map database 52 and then calculating the virtual sensor calculation information under the above-set calculation conditions; and a route calculation unit 55 for calculating a travel route for the main unit section Sla to travel based on the virtual sensor calculation information calculated by the virtual sensor information calculation unit 54 (i.e., the obstacle information extracted by the obstacle information extraction unit 54). The mobile robot 51 further has an input device 39 for inputting obstacle information on obstacles, information on virtual sensor setting, and information on the destination into the map database 52 and the virtual sensor setting change unit 57, and an output device 38 such as displays for outputting various information (e.g., map information, virtual sensor setting information, and travel route information).

Herein, the main unit portion 2 of the mobile robot 20 in FIG. 1A corresponds to the main unit section 51a of the mobile robot 51, and in the similar way, the obstacle detection sensor 4 corresponds to an obstacle detection sensor 56, the self location measurement unit 5 corresponds to the self location measurement unit 53, the map database 11 corresponds to the map database 52, the obstacle recognition unit 22 corresponds to the virtual sensor setting change unit 57 and the virtual sensor information calculation unit 54, the route calculation unit 6 corresponds to the route calculation unit 55, and the drive unit 7 corresponds to a drive unit 61.

It is understood that the obstacle detection sensor 56 may detect obstacles in an arbitrary detection region around the main unit section 51a, and the route calculation unit 55 may calculate travel routes based on the detection information by the obstacle detection sensor 56 in addition to the virtual sensor calculation information.

It is further understood that the mobile robot 51 has the virtual sensor setting change unit 57 for changing calculation conditions for the virtual sensor information calculation unit 54 to calculate virtual sensor calculation information, and the virtual sensor setting change unit 57 makes it possible to change the calculation conditions for calculating the virtual sensor calculation information based on the map information stored in the map database 52, the self location information 73 measured by the self location measurement unit 53, the virtual sensor calculation information calculated by the virtual sensor information calculation unit 54, the detection information by the obstacle detection sensor 56, and the travel route calculated by the route calculation unit 55.

Herein, it is understood that as an example of detailed specifications of the robot 51, the movable main unit section 51a in FIG. 1F, FIG. 1G, and FIG. 1H is made from a mobile unit 58 composed of left-side and right-side two drive wheels 59 which can be driven independently of each other and caster-type auxiliary two backup wheels 60. Each of the left-side and right-side drive wheels 59 can be controlled at a specified rotation speed by the drive unit 61 that uses left-side and right-side motors 61a, and a difference in rotation speed of both the drive wheels 59 allows change of course or turning. The main unit section 51a has a shape similar to rectangular parallelepiped shape with the longer sides thereof being in the backward and forward directions, and the left-side and right-side two drive wheels 59 and the left-side and right-side two backup wheels 60 are disposed at four corners, with the front two wheels being the drive wheels 59 while the rear two wheels being the backup wheels 60. These two drive wheels 59 and two backup wheels 60 correspond to four wheels 2w in FIG. 1A.

The self location measurement unit 53 is constituted of encoders 62 attached to rotary drive shafts of two drive wheels 59 and an odometry calculation unit 63 for calculating a self location from values of the encoders 62, and the route calculation unit 55 performs odometry calculation based on rotation speeds of the two drive wheels 59 acquired from these two encoders 62 so as to calculate the self location information 73 of the robot 51 in real time. The calculated location measurement information is specifically composed of a location of the main unit section 51a of the robot 51 and a posture (travel direction) thereof. A time-series difference of the self location information 73 additionally allows calculation of speed information on the robot 51.

As the obstacle detection sensor 56 for obstacle detection, a plurality of photoelectric sensors 64 and ultrasonic sensors 65 are used.

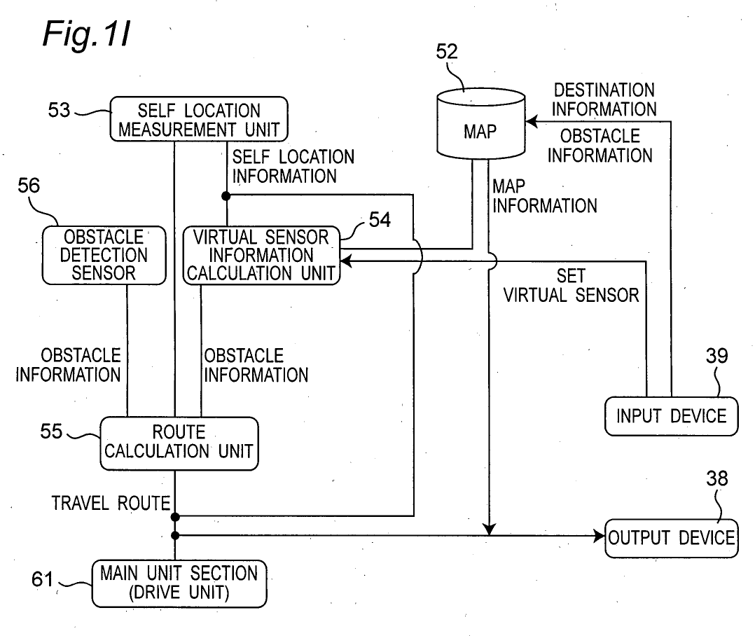

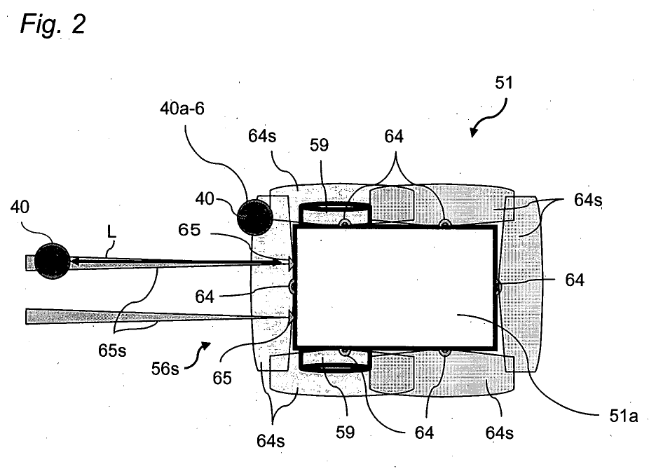

As shown in FIG. 2, the plurality of the photoelectric sensors 64 each capable of detecting in almost rectangular detection regions as shown by reference numeral 64s are arranged at the periphery of the main unit section 51a of the robot 51 (more specifically, one sensor each on the center sections of both front and rear surfaces of the main unit section 51a, and two sensors each on the center sections of both left-side and right-side lateral surfaces) so as to perform detection in adjacent regions surrounding the main unit section 51a of the robot 51. Moreover, the plurality of the ultrasonic sensors 65 having elongated detection regions as shown by reference numeral 65s are arranged on the front side (more specifically, two sensors disposed on the front surface of the main unit section 51a) so as to detect obstacles 40 in front. As for detection values from these obstacle detection sensors 56, an impassable region 40a-6 of the robot 51 is used as a detection value in the photoelectric sensors 64, while a distance L to the obstacles 40 is used as a detection value in the ultrasonic sensors 65. Therefore, the detection regions 64s of the photoelectric sensors 64 and the detection regions 65s of the ultrasonic sensors 65 constitute a first detection region 56s of the obstacle detection sensors 56 (corresponding to the first detection region 3 of the obstacle detection sensor 4 in the mobile robot 20 in FIG. 1A).

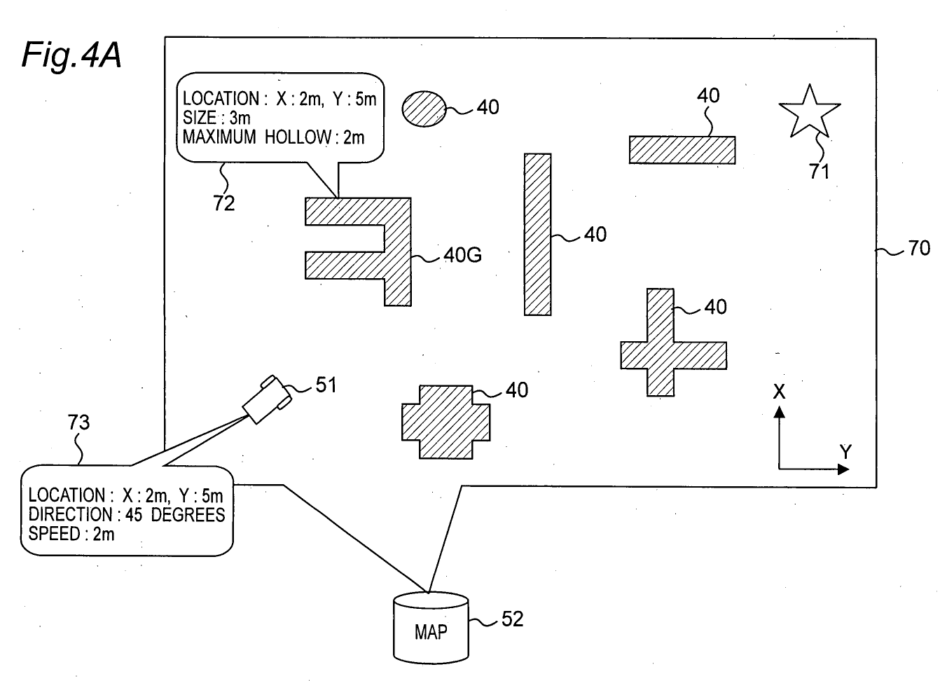

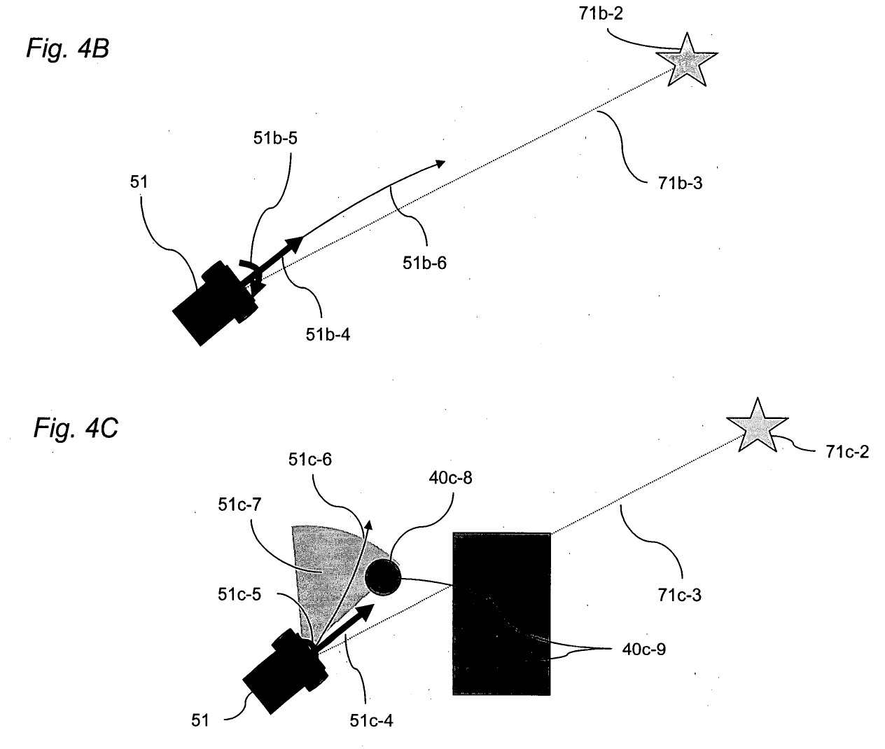

Moreover, as shown in FIG. 4A, as map information 70 stored in the map database 52, obstacle information 72 about positions, sizes, and shapes of the obstacles 40 as well as information on a destination 71 are registered. When calculation of the virtual sensor is performed, information on the mobile robot 51 is overlapped on top of the map information 70 based on the self location information 73.

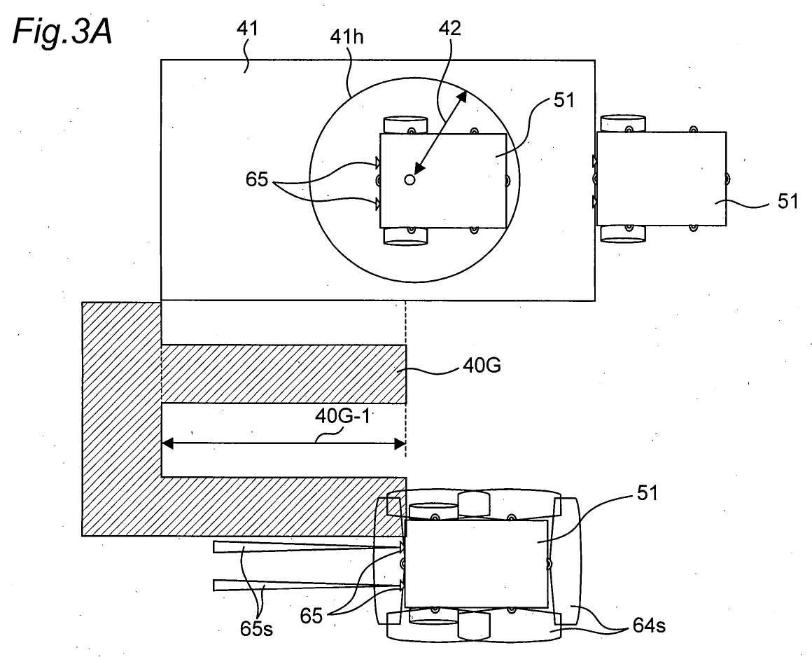

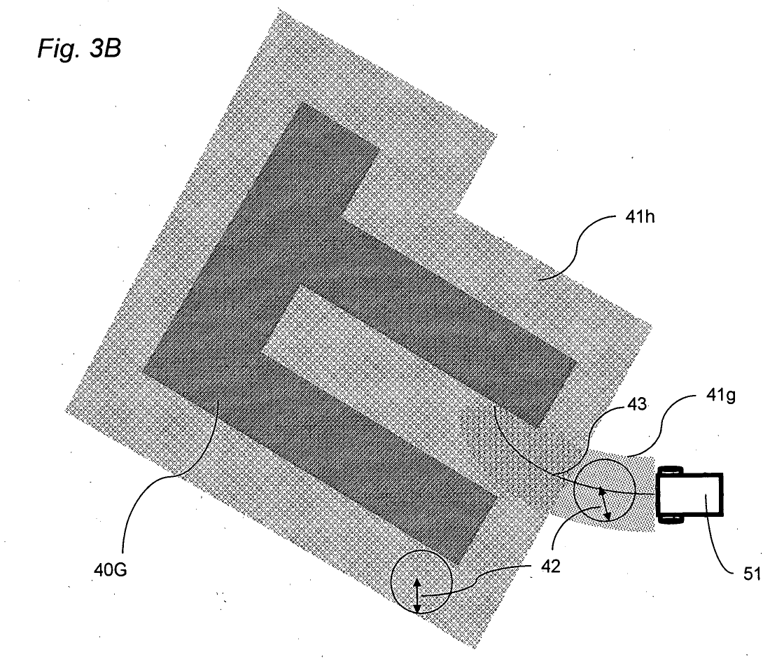

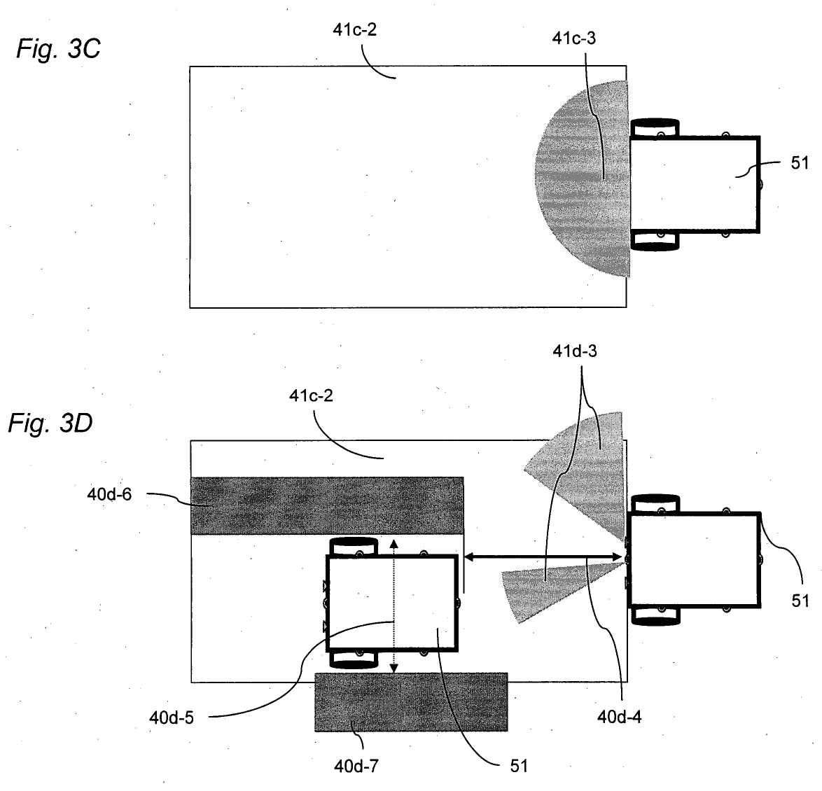

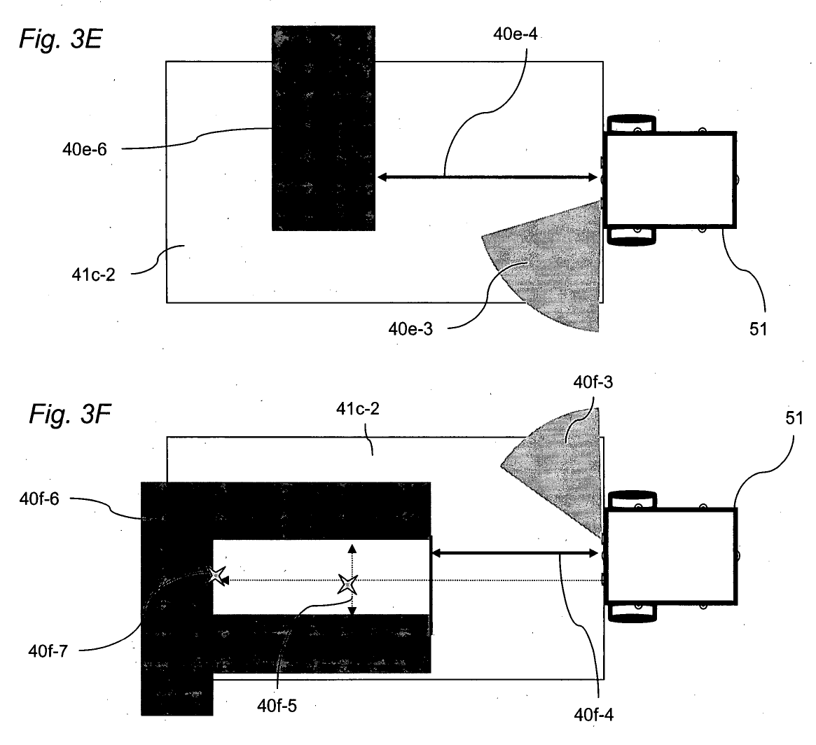

As for how to set the setting of the calculation conditions of the virtual sensor (the setting of a second detection region 41 of the virtual sensor (corresponding to the second detection region 21 of the virtual sensor in the mobile robot 20 in FIG. 1A)), in the case of the mobile robot 51 without the virtual sensor setting change unit 57 as shown in FIG. 1I, the second detection region 41 is, as shown in FIG. 3A, a rectangular region located in front of the mobile robot 51, having a width large enough to house a circle drawn by the mobile robot 51 during its rotation necessary for turning operation (turning operation for avoiding obstacles and the like) (a width two or more times larger than the rotation radius), and having a distance longer than a depth 40G-1 of a hollow of an obstacle 40G having the maximum hollow among the known obstacles 40 on the map 70 viewed from the mobile robot 51. It is to be noted that herein the depth 40G-1 of the hollow of the obstacle 40G is too deep to be covered by the elongated detection regions 65s of the ultrasonic sensors 65. It is to be noted that in the robot 51 shown in FIG. 1I, virtual sensor setting information may be inputted into the virtual sensor information calculation unit 54 from the input device 39 so that the second detection region 41 of the virtual sensor may be set arbitrarily. However, in this example, the setting of the virtual sensor cannot be changed during the robot travel operation.

The mobile robot 51 has the virtual sensor setting change unit 57 for changing the calculation conditions for the virtual sensor information calculation unit 54 to calculate the virtual sensor calculation information, and therefore once the second detection region 41 of the virtual sensor is set upon start of traveling of the mobile robot 51, it is possible to keep the setting of the region 41 or it is also possible to change the setting of the second detection region 41 of the virtual sensor in the virtual sensor setting change unit 57 with use of various information including obstacle information inputted into the virtual sensor setting change unit 57 from the obstacle detection sensor 56 while the robot 51 travels.

Description is given of an example of changing the setting of the second detection region 41 of the virtual sensor with use of various information such as obstacle discovery information while the mobile robot 51 travels.

During normal movement operation of the mobile robot 51 (before discovery of obstacles), the second detection region 41 of the virtual sensor may be set, for example, as shown in FIG. 3B, as a region 41g having a length 43 equal to a distance that the mobile robot 51 moves till the mobile robot 51 stops upon reception of a stop instruction while the mobile robot 51 is moving along the travel route (the distance varies depending on the speed of the mobile robot 51) and having a width large enough for a circle drawn by the mobile robot 51 during its rotation for its turning operation (turning operation for avoiding obstacles and the like) to pass (a width two or more times larger than a rotation radius 42).

Then, as shown in FIG. 3B, when, for example, the obstacle 40G comes into the second detection region 41g during normal operation of the virtual sensor (before discovery of obstacles), based on the detection location of the obstacle 40G, the shape and the location of the detected obstacle 40G are extracted from the map information 70 by the virtual sensor setting change unit 57, and the second detection region 41 may be changed so as to include an additional region 41h located around the obstacle 40 and having a width large enough for a circle drawn by the mobile robot 51 during its rotation for its turning operation (turning operation for avoiding obstacles and the like) to pass (a width two or more times larger than the rotation radius 42) in addition to the detection region 41g for normal operation.

It is to be noted that when the mobile robot 51 avoided the obstacle and then returned to the normal movement operation state (the state before obstacle discovery) as shown in FIG. 3B, the additional region 41h may be removed and only the detection region 41g for the normal operation may remain.

While detection is performed with use of the above-set second detection region 41 of the virtual sensor, virtual sensor calculation information is calculated by the virtual sensor information calculation unit 54, and the virtual sensor calculation information refers to information on obstacles to movement of the robot 51 in the second detection region 41 of the virtual sensor set on the map information 70, the information being extracted based on the self location information 73 of the robot 51 measured by the self location measurement unit 53 and the map information 70 stored in the map database 52. A specific example of the virtual sensor calculation information is information which allows the robot 51 to avoid obstacles and allows the robot 51 to move in consideration of information on the obstacles, and which is composed of a distance between the mobile robot 51 and the obstacle 40 and a range of movable angles of the mobile robot 51. Such information as the distance from the mobile robot 51 to the obstacle 40 and the range of movable angles of the mobile robot 51 is calculated depending on the presence/absence of obstacles in the second detection region 41 as described below as shown in FIG. 3C to FIG. 3F, and is inputted into the route calculation unit 55. Although in FIG. 3C to FIG. 3F, the second detection region 41 of the virtual sensor is not changed by the virtual sensor setting change unit 57 during travel operation, the same calculation applies even in the case where the setting is changed during the travel operation as described above.

(1) As shown in FIG. 3C, when the virtual sensor information calculation unit 54 can determine that no obstacle 40 is present ahead the travel direction of the mobile robot 51 based on the map information 70 stored in the map database 52 and the self location information on the mobile robot 51 measured by the self location measurement unit 53, the virtual sensor information calculation unit 54 produces calculation information indicating that the obstacle distance is infinite (∞) and the movable angle is all directions on the front surface of the mobile robot 51 as shown by reference numeral 41c-3. It is to be noted that herein the second detection region 41 of the virtual sensor is a rectangular detection region 41c-2 extending ahead the mobile robot 51, and the same detection region is employed in the following (2) to (4).

(2) As shown in FIG. 3D, when the virtual sensor information calculation unit 54 can determine that two obstacles 40d-6 and 40d-7 disposed facing each other are present ahead the travel direction of the mobile robot 51 and the virtual sensor information calculation unit 54 determines that a passable path 40d-5 is formed between these two obstacles 40d-6 and 40d-7 based on the map information 70 stored in the map database 52 and the self location information on the mobile robot 51 measured by the self location measurement unit 53, the virtual sensor information calculation unit 54 produces calculation information in which the distance from the mobile robot 51 to the obstacle 40d-6 that is closer to the front surface of the mobile robot 51 is regarded as a distance 40d-4 between the mobile robot 51 and the obstacle 40d-6, and two angle ranges 40d-3 composed of an angle direction for the robot 51 to enter the path 40d-5 between the two obstacles 40d-6 and 40d-7 and an angel direction for the robot 51 to avoid the path 40d-5 are regarded as movable angles of the mobile robot 51. The determination whether or not the path 40d-5 that the robot 51 can pass is formed between the two obstacles 40d-6 and 40d-7 may be made by the virtual sensor as shown below. For example, in terms of an algorithm, if there are two obstacles disposed facing each other, then it is determined in the virtual sensor information calculation unit 54 whether or not a distance between these two obstacles is equal to or larger than a width size of (entire width of the robot 51)+(safety allowance size), and if the virtual sensor information calculation unit 54 determines that the distance is equal to or larger than such a width size, then processing in FIG. 3D is executed with the determination that the robot 51 can pass, whereas if the virtual sensor information calculation unit 54 determines that the distance is less than such a width size, then processing in FIG. 3F is executed with the determination that the robot 51 cannot pass. It is understood that information on the robot 51 such as the width, the length, and the rotation radius at the time of turning is included in information used for setting the virtual sensor.

(3) As shown in FIG. 3E, when the virtual sensor information calculation unit 54 can determine that an obstacle 40e-6 is present directly in front of the travel direction of the mobile robot 51 based on the map information 70 stored in the map database 52 and the self location information of the mobile robot 51 measured by the self location measurement unit 53, the virtual sensor information calculation unit 54 produces calculation information in which the distance from the mobile robot 51 to the obstacle 40e-6 in the front surface direction of the mobile robot 51 is regarded as a distance 40e-4 between the mobile robot 51 and the obstacle 40e-6, and an angle direction 40e-3 for the mobile robot 51 to avoid the obstacle 40e-6 is regarded as a movable angle.

(4) As shown in FIG. 3F, when the virtual sensor information calculation unit 54 can determine that an obstacle 40f-6 is present directly in front of the travel direction of the mobile robot 51 and the virtual sensor information calculation unit 54 can determine that a hollow of the obstacle 40f-6 as viewed from the mobile robot 51 has a dead end 40f-7 or an impassable path 40f-5 based on the map information 70 stored in the map database 52 and the self location information of the mobile robot 51 measured by the self location measurement unit 53; the virtual sensor information calculation unit 54 regards the obstacle 40f-6 as an obstacle with a closed aperture portion and produces calculation information in which the distance from the front surface direction of the mobile robot 51 to the obstacle 40f-6 is regarded as a distance 40f-4 between the mobile robot 51 and the obstacle 40f-6, and an angle direction 40f-3 for the mobile robot 51 to avoid the obstacle 40f-6 is regarded as a movable angle of the mobile robot 51.

Next in the route calculation unit 55, the travel route of the mobile robot 51 is calculated as shown in FIG. 4B and FIG. 4C.

First, in the case (as shown in FIG. 3C) where it is determined in the virtual sensor information calculation unit 54 that no obstacle is present in the travel direction of the robot 51 based on the map information 70 stored in the map database 52 and the self location information of the mobile robot 51 measured by the self location measurement unit 53, a difference in angle between a direction 71b-3 toward a destination 71b-2 connecting the mobile robot 51 and the destination 71b-2 and a present travel direction 51b-4 of the mobile robot 51 measured by the self location measurement unit 53 is calculated by the route calculation unit 55 as shown in FIG. 4B, and a travel route 51b-6 produced by adding a turning speed component 51b-5 proportional to the angle different to a linear travel speed component is calculated by the route calculation unit 55. It is to be noted that the linear travel speed component of the robot 51 is set by an obstacle, or the distance to a destination, or the turning speed component.

As described above, calculating such a movement speed in the route calculation unit 55 allows travel along the travel route 51b-6. The travel speed calculated in the route calculation unit 55 is inputted into the drive unit 61 and at the travel speed, the mobile robot 51 travels. It is to be noted that if there is no obstacle and the like, then the robot 51 travels at its maximum speed.

Herein, the direction 71b-3 toward a destination 71b-2 connecting the mobile robot 51 and the destination 71b-2 can be obtained in the virtual sensor information calculation unit 54 or in the route calculation unit 55 separately where necessary. In the virtual sensor information calculation unit 54, calculation of the direction 71b-3 toward the destination 71b-2 is performed in the case where a region in the direction 71b-3 toward the destination 71b-2 is set as the second detection region 41 in the detection setting of the virtual sensor and the like. In this case, from the self location information sent to the virtual sensor and information on the destination in the map information, the direction 71b-3 toward the destination 71b-2 can be calculated in the virtual sensor information calculation unit 54. In the route calculation unit 55, the direction 71b-3 toward the destination 71b-2 is calculated for the purpose of using it for route calculation (herein it is also used for calculation of a difference in angle between the present travel direction of the robot 51 and its target (destination 71b-2)), or the like. As with the case of the virtual sensor information calculation unit 54, the direction 71b-3 can also be calculated in the route calculation unit 55 based on the self location information and the information on the destination in the map information. Moreover, when the present travel direction 51b-4 of the mobile robot 51 is obtained by the self location measurement unit 53, a method called odometry, for example, can be used for calculation. In the case of the present example, integrating the rotation speeds on both the wheels of the robot 51 allows calculation of the location and the direction of the robot 51.

Moreover, both the turning speed component 51b-5 and the linear travel speed component can be obtained by the route calculation unit 55. It is to be noted that while the setting of various gains may be set as parameters, necessary values are herein included in the algorism in advance and therefore description of setting units and the like is omitted to simplify explanation. As for the turning speed component, as stated in the present specification, a value obtained by obtaining a difference between “present travel direction” and “direction of destination” (or obtaining a difference between “travel direction” and “movable angle closest to the destination direction except an impassable region”) and by multiplying the difference by a proportional gain is regarded as a turning speed component. By this, direction control is performed so that the robot 51 faces the direction of its destination. The linear speed component may be calculated as shown below. First, a travel speed is set in conformity with a distance to the destination or a distance to an obstacle. As for the travel speed, a speed obtained at a maximum rotation speed that a motor of the robot can continuously provide is regarded as “maximum speed”, and in the vicinity of the destination or in close proximity to an obstacle, a distance from the robot 51 to the point that the robot 51 starts slowdown is Xd while a distance from the robot 51 to the destination or the obstacle is x, for example. If the destination nor the obstacle is not present in the distance Xd, then 100% of the maximum speed is set as the travel speed. If the destination or the obstacle is present in the distance Xd, then the travel speed is obtained by the following formula:
[travel speed]=[maximum speed]*(1−[slowdown gain]*(Xd−x))

As for the linear speed component, when the travel is attempted at high linear speed with a large turning component, there is a possibility that the robot might fall down to the outside of the turning direction due to centrifugal force, and therefore the travel speed is obtained by the following formula:
[linear speed component]=[travel speed]*(1−[turning slowdown gain]*|turning speed component|)

As for the maximum speed, as described above, a speed obtained at the maximum rotation speed that the motor of the robot 51 can continuously provide is regarded as “maximum speed”. More specifically, the maximum speed can be calculated in the following formula in this example:
[maximum speed]=[radius of wheel]*[maximum continuous rotation number of motor]*[gear ratio]

The settings regarding the maximum speed are included in the algorism of the route calculation unit 55 as described above.

Moreover, as shown in FIG. 4C, in the case that it has been determined in the virtual sensor information calculation unit 54 that an obstacle is present in the travel direction of the robot 51 based on the map information 70 stored in the map database 52 and the self location information of the mobile robot 51 measured by the self location measurement unit 53, and the calculation information of the obstacle detection sensor 56 or the virtual sensor includes information on the obstacle 40 (the case as shown in FIG. 3D to FIG. 3F), the following route is calculated in the route calculation unit 55.

As shown in FIG. 4C, in the case where an obstacle 40c-9 is present in the direction of the destination or near the robot 51, a travel route 51c-6 is calculated in the route calculation unit 55 by adding a turning speed component 51c-5 to the linear travel speed component so that the robot 51 moves within movable angles 51c-7 of the robot 51 calculated as the virtual sensor calculation information, within the range of angles except an impassable region 40c-8 detected by the obstacle detection sensor 56, and in the direction closest to a direction 71c-3 toward a destination 71c-2 connecting the mobile robot 51 and the destination 71c-2 to each other. Also a speed slowed down in conformity with the distance from the mobile robot 51 to the obstacle 40 is calculated in the route calculation unit 55. The travel speed calculated in the route calculation unit 55 is inputted into the drive unit 61 to drive the mobile robot 51.

It is to be noted that the turning speed component 51c-5 and the linear travel speed component are obtained in the same way as described above. As for the turning speed component, as stated in the present specification, a value obtained by obtaining a difference between “present travel direction” and “movable angle closest to the destination direction except an impassable region” and by multiplying the difference by a proportional gain is regarded as a turning speed component.

The linear speed component may be calculated as shown below. First, a travel speed is set in conformity with a distance to the destination or a distance to an obstacle. As for the travel speed, a speed obtained at a maximum rotation speed that a motor of the robot 51 can continuously provide is regarded as “maximum speed”, and in the vicinity of the destination or in close proximity to an obstacle, a distance from the robot 51 to the point that the robot 51 starts slowdown is Xd while a distance from the robot 51 to the destination or the obstacle is x, for example. If the destination nor the obstacle is not present in the distance Xd, then 100% of the maximum speed is set as the travel speed. If the destination or the obstacle is present in the distance Xd, then the travel speed is obtained by the following formula:
[travel speed]=[maximum speed]*(1−[slowdown gain]*(Xd−x))

As for the linear speed component, when the travel is attempted at high linear speed with a large turning component, there is a possibility that the robot 51 might fall down to the outside of the turning direction due to centrifugal force, and therefore the linear speed component is obtained by the following formula:
[linear speed component]=[travel speed]*(1−[turning slowdown gain]*|turning speed component|)

Thus, when the obstacle 40 is present in the travel direction of the mobile robot 51, a travel route for the mobile robot 51 to avoid the obstacle 40 is taken, and after the mobile robot 51 passes the obstacle 40 (in other words, immediately after the obstacle disappears from the first and second detection regions), a route toward the destination 71c-2 is taken (calculation as shown in FIG. 4B is performed) to go to the destination 71c-2.

It is to be noted that movement of the mobile robot 51 along the travel route calculated by the route calculation unit 55 is implemented by controlling the rotation speeds of the left-side and right-side drive wheels 59 of the left-side and right-side motors 61a in the drive unit 61 as shown below. That is, the linear travel speed component is obtained as an average speed of the left-side and the right-side two drive wheels 59, while the turning speed component is obtained as a speed difference between the left-side and the right-side two drive wheels 59.

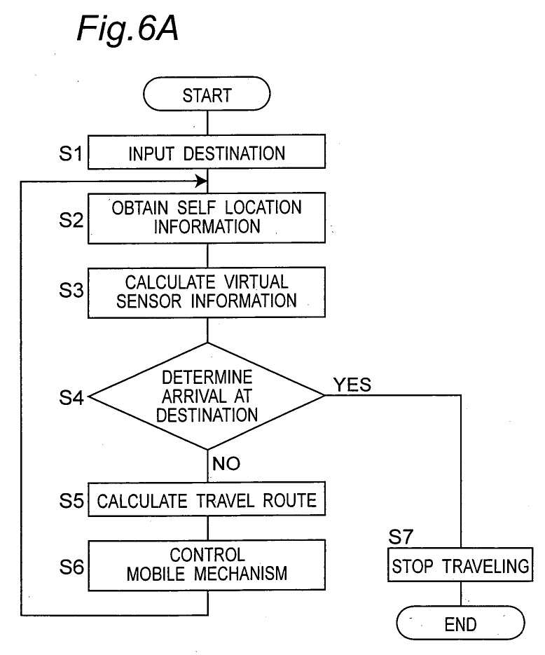

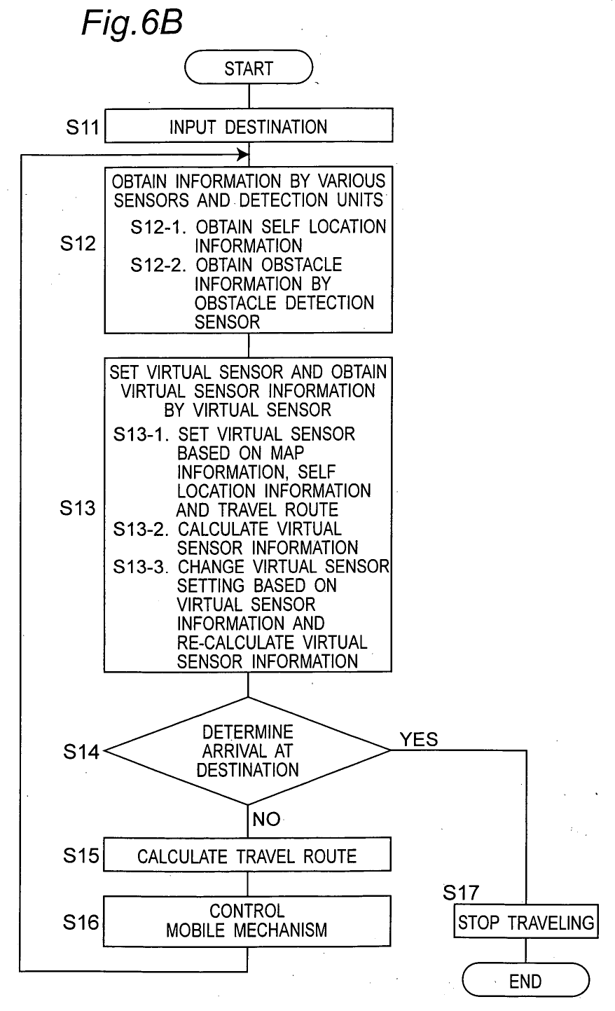

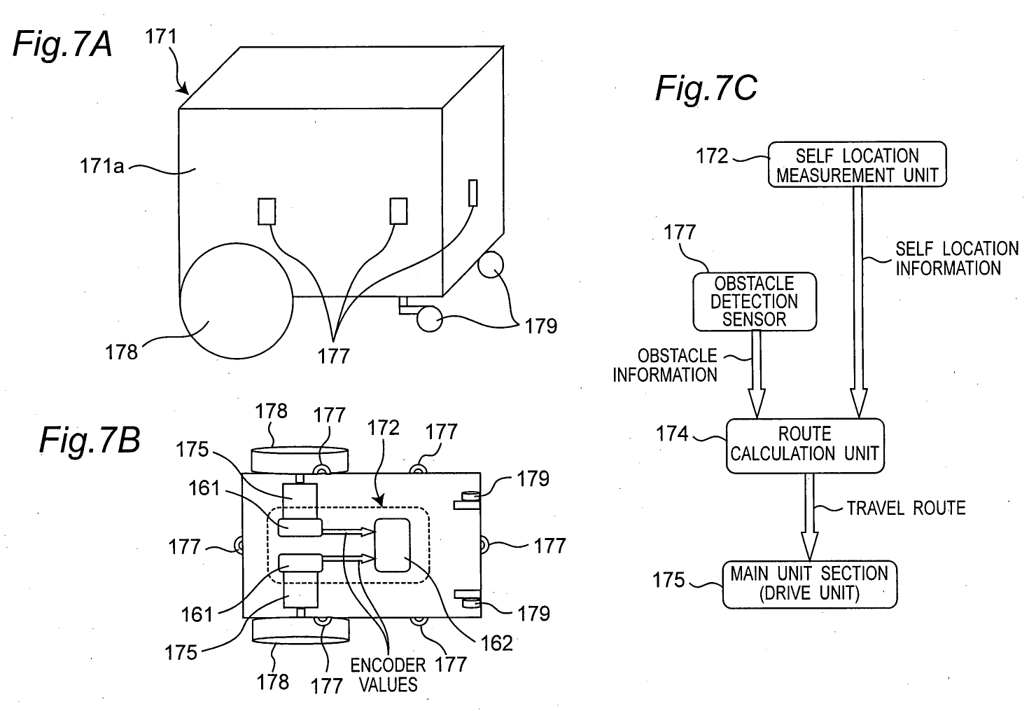

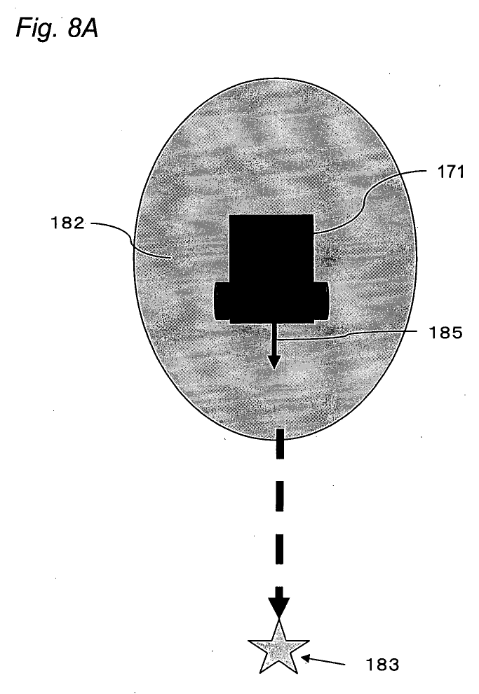

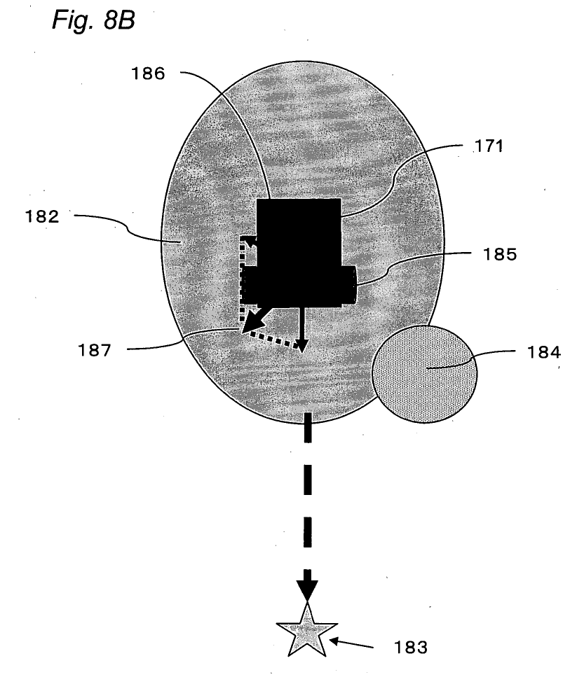

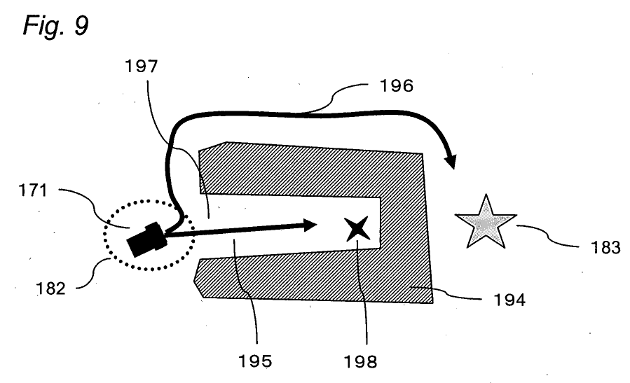

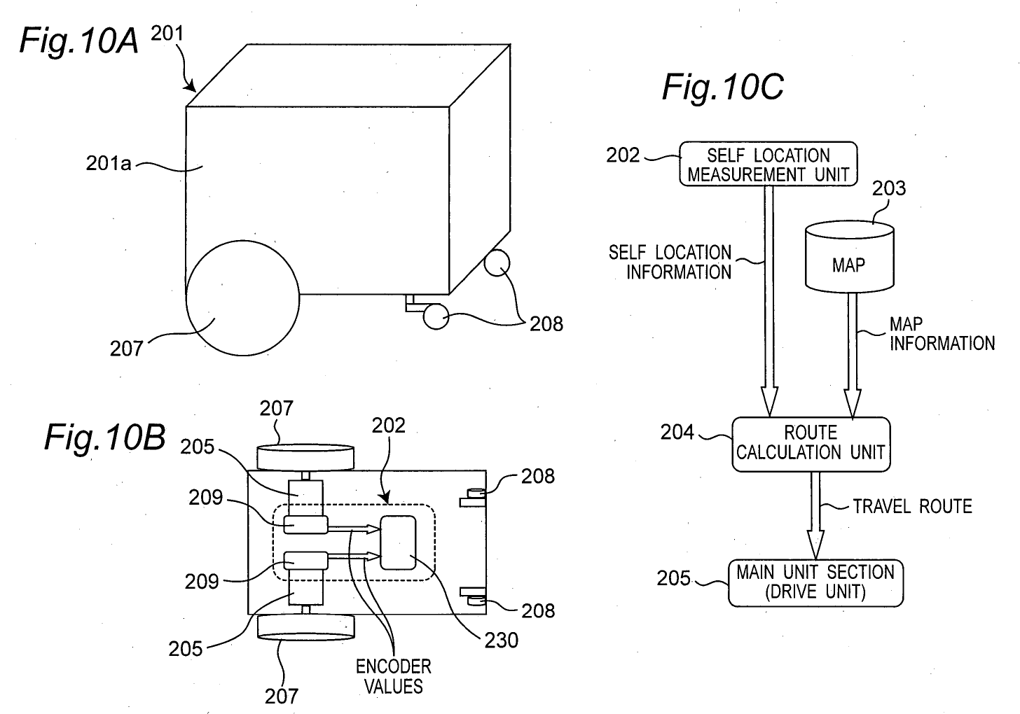

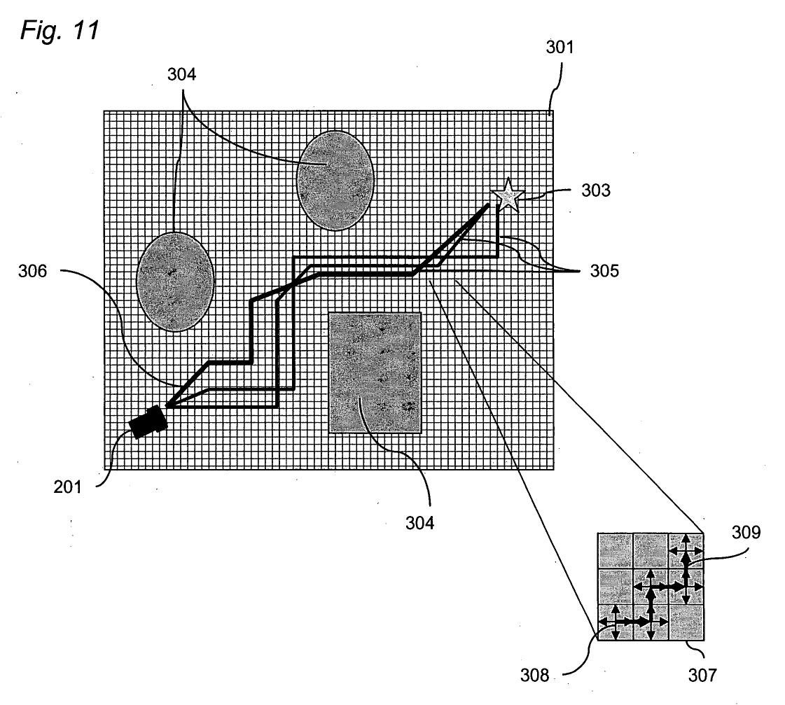

The basic processing flow of the mobile robot 51 having the thus-described configuration is shown below with reference to FIG. 6A to FIG. 6B.

In the case where the mobile robot 51 does not change the setting of the second detection region 41 of the virtual sensor during travel operation, the processing is executed according to the basic flow as shown in FIG. 6A.

Step S1: first, a travel destination of the robot 51 is inputted into the map database 52 by the input device 39. The destination on the map information 70 is updated upon the input and the following steps till arrival at the destination are executed. It is to be noted that when the travel destination is inputted, a coordinate of the destination and an arrival condition distance for use in arrival determination are inputted.

Step S2: self location information 73 of the robot 51 is obtained by the self location measurement unit 53.

Step S3: virtual sensor calculation information is calculated by the virtual sensor information calculation unit 54 based on the self location information 73 obtained in step S2 and the map information 70.

Step S4: the self location information 73 of the robot 51 obtained in step S2 and information on the destination in the map information 70 are compared by the route calculation unit 55 to determine whether or not the robot 51 has arrived at the destination. At this point, a distance from the self location (present location) of the robot 51 to the destination is calculated from a coordinate of the self location (present location) and a coordination of the destination by the route calculation unit 55, and if the route calculation unit 55 determines that the distance is within the arrival condition distance inputted in step S1, then it is determined that the robot 51 has arrived at the destination. With the determination, the information on the destination is cleared from the map information 70, moving operation of the robot 51 is ended by the drive unit 61 (step S7), and the robot 51 is put into a standby state for new destination input (step S1).

Step S5: if the robot 51 does not yet arrive at the destination, that is, if the route calculation unit 55 determines that the distance from the self location of the robot 51 to the destination is larger than the arrival condition distance, then a travel route of the robot 51 is calculated by the route calculation unit 55 based on the information calculated in steps S2 and S3.

Step S6: the movement of the robot 51 is controlled by the drive unit 61 so as to allow the robot 51 to travel along the travel route calculated in step S4. After the execution of step S5, the procedure returns to step S2.

Further, in the case where the mobile robot 51 changes the setting of the second detection region 41 of the virtual sensor during the travel operation by using the obstacle detection sensor 56 and the virtual sensor setting change unit 57, processing is executed according to the flow as shown in FIG. 6B.

Step S11: first, a travel destination of the robot 51 is inputted into the map database 52 by the input device 39. The destination on the map information 70 is updated upon the input and the following steps till arrival at the destination are executed. It is to be noted that when the travel destination is inputted, a coordinate of the destination and an arrival condition distance for use in arrival determination are inputted.

Step S12: various information is obtained by the obstacle detection sensor 56 and the self location measurement unit 53. More specifically, the following steps 12-1 and 12-2 are executed.

Step S12-1: self location information 73 of the robot 51 is obtained by the self location measurement unit 53.

Step S12-2: detection information on obstacles is obtained by the obstacle detection sensor 56.

Step S13: calculation conditions of the virtual sensor calculation information are set based on the information obtained in step S12, and the virtual sensor calculation information is calculated by the virtual sensor information calculation unit 54. More specifically, the following steps S13-1, S13-2, and S13-3 are executed.

Step S13-1: if necessary, the setting of the calculation conditions of the virtual sensor calculation information is changed by the virtual sensor setting change unit 57 based on the self location information 73 obtained in step S12, the detection information on obstacles, and the map information 70 stored in the map database 52.

Step S13-2: the virtual sensor calculation information is calculated by the virtual sensor information calculation unit 54 based on the self location information 73 obtained in step S12, under the calculation conditions from the virtual sensor setting change unit 57 and with use of the map information 70 stored in the map database 52.

Step S13-3, if necessary, the setting of the calculation conditions of the virtual sensor calculation information is changed by the virtual sensor setting change unit 57 based on the virtual sensor calculation information calculated in step S13-2, and virtual sensor calculation information is calculated again by the virtual sensor information calculation unit 54 under the changed calculation conditions from the virtual sensor setting change unit 57 and with use of the map information 70 stored in the map database 52.

Step S14: the self location information 73 of the robot 51 obtained in step S12 and the information on the destination in the map information 70 are compared by the route calculation unit 55 to determine whether or not the robot 51 has arrived at the destination. At this point, a distance from the self location (present location) of the robot 51 to the destination is calculated from a coordinate of the self location (present location) and a coordination of the destination by the route calculation unit 55, and if the route calculation unit 55 determines that the distance is within the arrival condition distance inputted in step S11, then it is determined that the robot 51 has arrived at the destination. With the determination, the information on the destination is cleared from the map information 70, moving operation of the robot 51 is ended by the drive unit 61 (step S17), and the robot 51 is put into a standby state for new destination input (step S1).

Step S15: if the robot 51 does not yet arrive at the destination, that is, if the route calculation unit 55 determines that the distance from the self location of the robot 51 to the destination is larger than the arrival condition distance, then a travel route of the robot 51 is calculated by the route calculation unit 55 based on the information calculated in steps S12 and S13.

Step S16: the movement of the robot 51 is controlled by the drive unit 61 so as to allow the robot 51 to travel along the travel route calculated in step S15. After the execution of step S16, the procedure returns to step S12.

With such a mechanism of the mobile robot 51, obstacles present in long distance or wide range which cannot be detected by the real obstacle detection sensor 56 due to physical properties of the sensor can be detected in the second detection region 41 of the virtual sensor in accordance with the basic flow in which the setting of the second detection region 41 of the virtual sensor is not changed during travel operation. For example, dead-end paths can be detected in advance by the second detection region 41 of the virtual sensor, which makes it possible to avoid these paths in advance, thereby allowing prevention of the robot 51 from accidentally entering the dead-end paths and performing inefficient movement or being caught in a deadlock. As for the calculation amount in route calculation, the calculation amount in virtual sensor calculation is proportional to (retrieval calculation of the detection area of the second detection region 41 of the virtual sensor=detection area/accuracy), and therefore, at worst, if the entire travel range is set as a detection region, the calculation can be conducted with a considerably small calculation amount compared to the conventional example 2 in which the calculation amount is proportional to the square of (detection area/accuracy) Therefore, in the mobile robot under the environments that obstacles are present, real time and efficient travels to destinations are implemented.

In the present invention, the virtual sensor can be set, and so the properties (e.g., size and direction of the detection region) can be freely set without being restricted to physical detection properties of real sensors in particular. Consequently, it is possible to obtain information undetectable by real sensors, that is for example, the back sides of obstacles or remote spots can be retrieved, the shapes of obstacles can be recognized based on the map information 70 in the map database 52 as described in the above example to detect the surroundings of the recognized obstacles. Further, it becomes unnecessary to give consideration to issues which can arise when real sensors are mounted such as an issue of detection accuracy and detection region, an issue of the number of sensors and installation, an issue of interference between sensors, and an issue of influence of surrounding environments.

Further, by combining the virtual sensor with the obstacle detection sensor 56 that is a real sensor, unknown obstacles not registered in the map database 52 and moving obstacles can be detected by the obstacle detection sensor 56, allowing the robot to avoid these unknown obstacles and moving obstacles. Further, the obstacles detected by the real obstacle detection sensor 56 may be registered in the map information in the map database 52 by a map registration unit 69 (see FIG. 1H), and by updating the map database 52 thereby, calculation of more accurate virtual sensor calculation information may be achieved.

Moreover, mounting the virtual sensor setting change unit 57 makes it possible to change the calculation setting in accordance with the state of the robot or the surrounding conditions, and so in the spot where smaller number of obstacles are present, it is possible to set the detection region to be small and the accuracy to be low, which allows implementation of high-accuracy detection while the entire calculation amount is kept small by increasing the detection region or increasing the accuracy only when needs arise. Not only the accuracy and the detection region, but also the properties can be changed if necessary, and it is also possible, for example, to give functions of a plurality of sensors to the virtual sensor only by switching the calculation setting.

Herein, a method for optimum setting of the virtual sensor in the present invention is to set the detection region and the accuracy to be requisite minimum in conformity with the movement properties of the robot and the properties of obstacles as stated in the above example. Smaller detection region and lower detection accuracy decrease the calculation amount and reduces a load on processing units such as calculation units. Further, the optimum setting is preferably provided not only to the detection region but also to the detection properties if necessary.

Herein the detection properties refer to those “extractable (detectable)” as information by the virtual sensor, and are exemplified by the followings.

(1) Information on the presence/absence of obstacles in the second detection region of the virtual sensor. Information on location and direction of the closest obstacle.

This allows the virtual sensor to be used like a real sensor.

(2) Information for determining whether or not paths are passable.

Information for the virtual sensor to determine whether or not the robot can pass blind alleys or labyrinths.

(The second detection region is expanded in sequence in the direction of the travel route of the robot to detect whether or not an exist of the path is found.)

(3) Information on types of obstacles (e.g., weight and material)

The information may be registered as the properties of the obstacles in the map database together with the location and the shape of obstacles.

In the case of light obstacles, it is possible to select an option of pushing them aside by the robot.

In the case of obstacles made of fragile materials, the information is used to determine if the robot avoids them cautiously or not.

Moreover, in the case where the obstacle detection sensor 56 and the virtual sensor are combined, it is possible to allot their roles while making the most of advantages of both the real obstacle detection sensor 56 and the virtual sensor. For example, the real obstacle detection sensor 56 as described in the above example is preferably used for detection in the detection region around the robot 51 for the purpose of ultimate security and detection in a long range ahead of the robot 51 for avoidance of unknown obstacles, while the virtual sensor is preferably used for detection in the region difficult to detect by the real sensor, that is, for detecting obstacles on the travel route of the robot 51 in response to the travel situation of the robot 51 and collecting detailed information on the surrounding of an obstacle during obstacle detection operation.

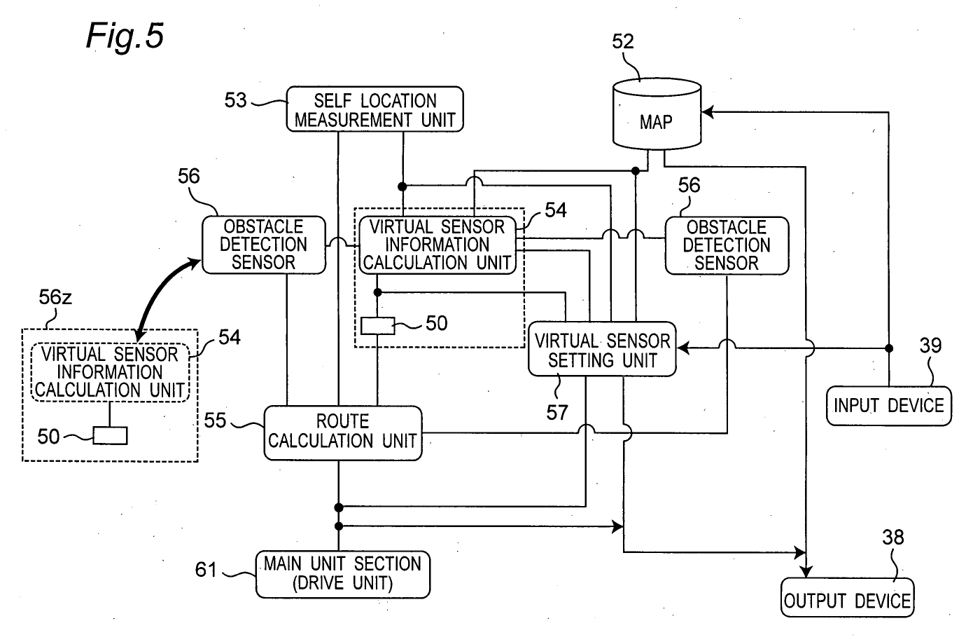

As for a method for calculating an optimum travel route, the method for route calculation based on the information by the real obstacle detection sensor 56 is preferably used without modification. This is because the virtual sensor calculation information itself has the same information contents as the real obstacle detection sensor 56 and so it is not necessary to distinguish the information, and also because when a virtual sensor is used in place of an actual obstacle detection sensor 56 in the development stage, and a sensor having desired specifications becomes commercially available, the virtual sensor (e.g., a replaceable virtual sensor 56z composed of a virtual sensor information calculation unit 54 and a conversion unit 50 shown in FIG. 5) can be easily replaced (see an arrow in FIG. 5) with an actual sensor.

By utilizing the properties of the virtual sensor, it is also possible to provide a conversion unit 50 as shown in FIG. 5 for converting virtual sensor calculation information into an output signal identical to (having the same kind as that of) a signal outputted when the obstacle detection sensor 56 detects an obstacle in actuality. In this case, since an output signal from the virtual sensor may be made identical to an output signal from the real obstacle detection sensor 56 by the conversion unit 50, the effect of adding a sensor or changing its installation position can be tested by changing, for example, the setting of a detection region 21 in the virtual sensor without actually adding the sensor or changing its installation position. It is also easy to replace the real obstacle detection sensor 4 with a virtual sensor. It is also easy to use the virtual sensor conversely in place of the real obstacle detection sensor 56. This makes it possible to test the effect of adding a sensor without actually adding the sensor or changing its installation position in mobile robots in an experimental state or under adjustment.

Herein, for comparison with the virtual sensor, the real obstacle detection sensor is exemplified by the followings.
(1) sensors to determine the presence/absence of obstacles in a region (e.g., area sensors)
(2) sensors to detect distances to obstacles (e.g., ultrasonic sensors or laser sensors)
(3) sensors to detect the presence/absence of obstacles in a certain angle range and distance information (e.g., photoelectric sensors or laser scanners)

The virtual sensor mentioned in the present example in FIG. 5 functions as a variation of the sensors (3). For example, if the virtual sensor is used as a sensor to detect an angle region in the absence of obstacles, the function of the sensor become synonymous with the function to detect an angle range in which the robot is movable. In terms of application of actual sensors, those not only detecting physical values but also processing these values into meaningful data to some extent in the sensor and then outputting the resultant data can also be considered as sensors. For example, the sensors executing scanning or the range sensors using stereo cameras in the sensors (3) fall within this category.

More particularly, detection information obtained based on the information detected by physical devices in a sensor can be called “detection information” by the sensor.

The “calculation information” of the virtual sensor refers to “information extracted from information stored in map database”. While the real sensors are subject to physical restrictions of the real sensors themselves, the virtual sensors can extract any information as long as information is preset in the map database, or to put it the other way around, what is necessary is to register necessary data in the database. Consequently, there is no limit on detectable information, and as a result, the “calculation information” of the virtual sensor includes the contents of the “detection information” of the real sensor.

Detailed description will be herein given of the case in which, as described above, the calculation conditions for calculating the virtual sensor calculation information are changed by the virtual sensor setting change unit 57 based on the map information stored in the map database 52, the self location information 73 measured by the self location measurement unit 53, the virtual sensor calculation information calculated by the virtual sensor information calculation unit 54, the detection information by the obstacle detection sensor 56, and the travel route calculated by the route calculation unit 55.

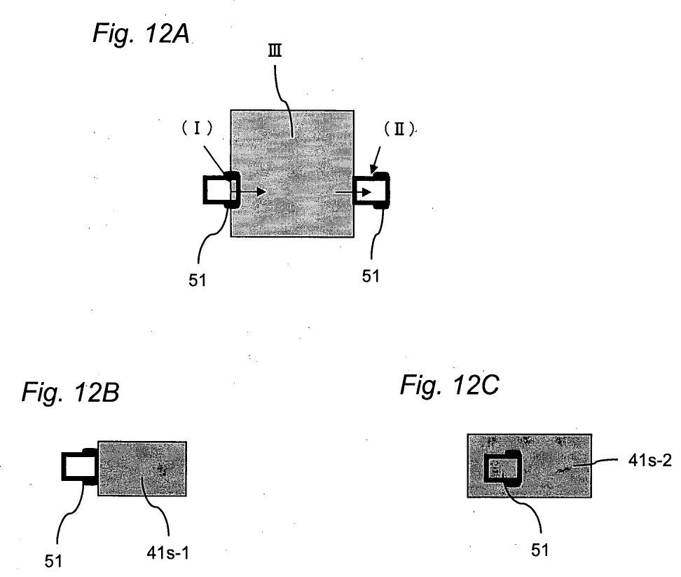

First, description will be given of the case in which the calculation conditions are changed by the virtual sensor setting change unit 57 based on the map information. When the normal state of the second detection region 41 is as shown in FIG. 3A, and in this state, the robot 51 attempts to enter a region III having a large number of obstacles shown in the map information stored in the map database 52 as shown in FIG. 12A (robot 51 is in the I state), the calculation conditions are changed by the virtual sensor setting change unit 57 from the setting state of a normal second detection region 41s-1 (FIG. 12B), to the setting state of a second detection region 41s-2 for regions having a large number of obstacles (FIG. 12C). In the setting state of the normal second detection region 41s-1, obstacle detection is performed only in the region in front of the rotor 41 as shown in FIG. 12B, whereas in the setting state of the second detection region 41s-2 for regions having a large number of obstacles, not only in the front region of the robot 51, but also in a region around the robot 51, i.e., an omnidirectional region, a present safely stopping distance (a distance to travel till speed stop) is set, and in the set region, obstacle detection is performed as shown in FIG. 12C. When the robot 51 is about to exit the region III having a large number of obstacles shown in the map information (the robot 51 is in the II state), the calculation conditions are changed by the virtual sensor setting change unit 57 from the setting state of the second detection region 41s-2 for regions having a large number of obstacles (FIG. 12C) to the normal setting state of the second detection region 41s-1 (FIG. 12B).

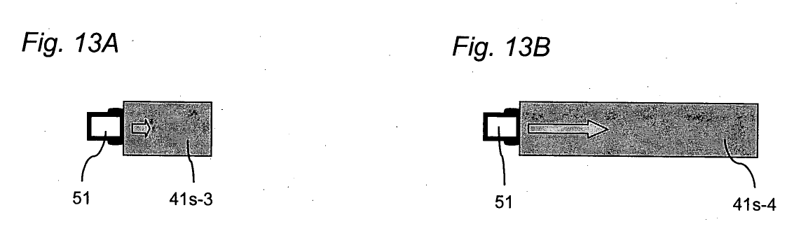

Description is now given of the case in which the calculation conditions are changed by the virtual sensor setting change unit 57 based on the self location information (e.g., speed information). When a normal second detection region 41 is as shown in FIG. 3A, and in this state, the movement speed of the robot 51 becomes equal to or larger than a threshold value, the calculation conditions are changed by the virtual sensor setting change unit 57 from the setting state of a second detection region 41s-3 for low speed (FIG. 13A) to the setting state of a second detection region 41s-4 for high speed (FIG. 13B) The setting state of the second detection region 41s-3 for low speed is equal to the setting state of the normal second detection region 41s-1 in FIG. 12B, whereas in the setting state of the second detection region 41s-4 for high speed, a distance that the robot 51 can safely stop at a present speed (a distance to travel till speed stop) is set in front of the robot 51, and in the set region, obstacle detection is performed as shown in FIG. 13B. When the movement speed of the robot 51 becomes less than the threshold value, the calculation conditions are changed by the virtual sensor setting change unit 57 from the setting state of the second detection region 41s-4 for high speed (FIG. 13B) to the setting state of the second detection region 41s-3 for low speed (FIG. 13A).

Next, in the case where the calculation conditions are changed by the virtual sensor setting change unit 57 based on the virtual sensor calculation information, as already described above, when the virtual sensor detects an obstacle (when an obstacle is present in the second detection region 41), the calculation conditions are changed by the virtual sensor setting change unit 57 from the setting state of the normal second detection region 41g (FIG. 3A) to the setting state of the second detection region 41 after the end of obstacle detection including the additional region 41h (FIG. 3B). When the virtual sensor detects no obstacles (when obstacles disappear from the second detection region 41), the calculation conditions are changed from the setting state of the second detection region 41 after the end of obstacle detection including the additional region 41h (FIG. 3B) to the setting state of the normal detection region 41g (FIG. 3A).

Next, in the case where the calculation conditions are changed by the virtual sensor setting change unit 57 based on the travel route, when the robot 51 is turned, the calculation conditions are changed, depending on the length of a distance that the robot 51 travels along the travel route of the robot 51 till the robot 51 stops upon reception of a stop instruction (the distance varies depending on the speed of the mobile robot), from the setting state of the normal second detection region 41g (FIG. 3A) to the setting state of a region including a width large enough for a circular orbit drawn by the robot 51 to pass (two or more times larger than the rotation radius 42), as shown in FIG. 3B. Upon termination of the turning operation of the robot 51, the calculation conditions are changed from the setting state of the detection region including the width large enough for the circular orbit drawn by the robot 51 to pass (two or more times larger than the rotation radius 42) to the setting state of the normal second detection region 41g (FIG. 3A).

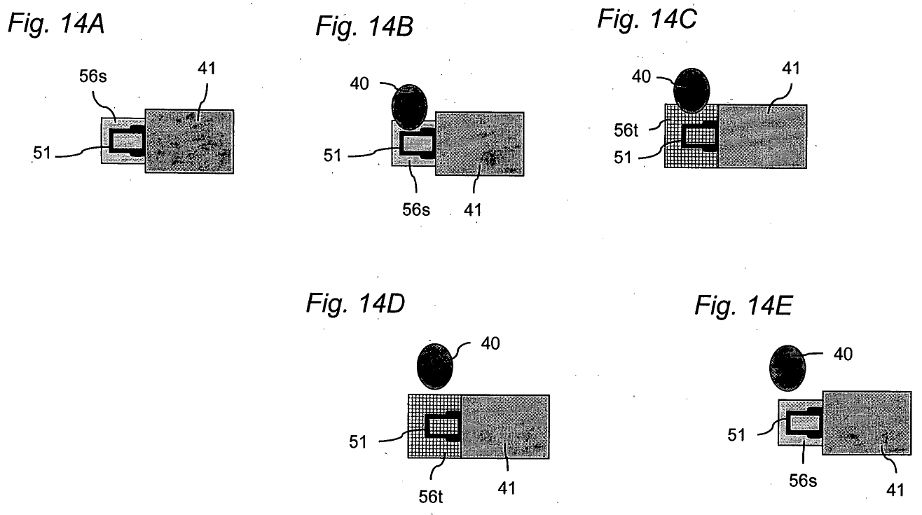

Description is now given of the case in which the calculation conditions are changed by the virtual sensor setting change unit 57 based on the detection information by the obstacle detection sensor 56. FIG. 14A shows a normal setting region composed of a first detection region 56s of the obstacle detection sensor 56 and the second detection region 41 of the virtual sensor. As shown in FIG. 14B, when an obstacle 40 is detected in the first detection region 56s of the obstacle detection sensor 56, the calculation conditions are changed by the virtual sensor setting change unit 57 from the normal setting region in FIG. 14A to such a state that not only in the front region of the robot 51, but also in a region around the robot 51, i.e., an omnidirectional region, a present safely stopping distance (a distance to travel till speed stop) is additionally set as the region of a virtual sensor, and the additionally set region and the first detection region 56s are combined to produce a detection region 56t. In the detection region 56t and the second detection region 41, obstacle detection is performed as shown in FIG. 14C. When the obstacle 40 is no longer detected in the detection region 56t composed of the additionally set region and the first detection region 56s as shown in FIG. 14D, the calculation conditions are changed by the virtual sensor setting change unit 57 so as to return to the normal setting region as shown in FIG. 14E.

Although the mobile robot assumed in the present embodiment is an independently driven two-wheel mobile robot with auxiliary wheels, other mobile mechanisms may be employed. The present embodiment is applicable to, for example, mobile mechanisms which take curves by a steering handle like automobiles, legged-walking type mobile mechanisms without wheels, and ship-type mobile robots which travel by sea. In such cases, in conformity with the properties of individual mobile mechanisms, virtual sensor settings and travel route calculation methods may be adopted. Further, although the assumed travel type in the present embodiment is travel on two-dimensional plane, the present embodiment may be applied to travel in three-dimensional space. In this case, the virtual sensor can easily adapt to the three-dimensional travel by setting the detection region in three dimension. Therefore, the technology of the present invention is applicable to airframes such as airships and airplanes as well as to movement of the head section of manipulators.

By properly combining the arbitrary embodiments of the aforementioned various embodiments, the effects possessed by the embodiments can be produced.

The mobile robot in the present invention is capable of implementing real-time and efficient travels to destinations under the environment that obstacles are present, and therefore is applicable to robots which operate in a self-reliant manner in public places such as factories, stations, and airports as well as to household robots.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A mobile robot comprising:
a movable robot main unit section;
a self location measurement unit for measuring a self location of the main unit section;
a map database for storing map information on a travel range of the main unit section;
an obstacle information extraction section for extracting obstacle information on obstacles to movement of the main unit section in a detection region of a virtual sensor set on the map information and capable of detecting the obstacle information, based on self location information measured by the self location measurement unit and the map information stored in the map database; and
a route calculation unit for calculating a travel route for the main unit section to travel based on the obstacle information extracted by the obstacle information extraction section.

2. The mobile robot as defined in claim 1, further comprising an obstacle detection sensor for detecting an obstacle in a detection region around the main unit section, wherein the route calculation unit calculates the travel route for the main unit section to travel based on detection information from the obstacle detection sensor in addition to the obstacle information extracted by the obstacle information extraction section.

3. The mobile robot as defined in claim 2, further comprising a conversion unit for converting the obstacle information extracted by the obstacle information extraction section into a signal identical to a signal outputted as the detection information into the route calculation unit by the obstacle detection sensor and outputting the converted signal to the route calculation unit.

4. The mobile robot as defined in claim 1, further comprising a virtual sensor setting change unit for changing extraction conditions for the obstacle information extraction section to extract the obstacle information.

5. The mobile robot as defined in claim 2, further comprising a virtual sensor setting change unit for changing extraction conditions for the obstacle information extraction section to extract the obstacle information.

6. The mobile robot as defined in claim 3, further comprising a virtual sensor setting change unit for changing extraction conditions for the obstacle information extraction section to extract the obstacle information.

7. The mobile robot as defined in claim 5, wherein the virtual sensor setting change unit changes extraction conditions for the obstacle information extraction section to extract the obstacle information based on at least any one of the map information stored in the map database, the self location information measured by the self location measurement unit, the obstacle information extracted by the obstacle information extraction section, the detection information by the obstacle detection sensor, and the travel route calculated by the route calculation unit.

8. The mobile robot as defined in claim 6, wherein the virtual sensor setting change unit changes extraction conditions for the obstacle information extraction section to extract the obstacle information based on at least any one of the map information stored in the map database, the self location information measured by the self location measurement unit, the obstacle information extracted by the obstacle information extraction section, the detection information by the obstacle detection sensor, and the travel route calculated by the route calculation unit.
